(19) United States
(12) Patent Application Publication
(10) Pub. No.: US 2006/0038764 A1
(43) Pub. Date: Feb. 23, 2006

(54) Source driver, electro-optic device, and driving method

(76) Inventors: Masami Takahashi, Chino (JP); Katsuhiko Maki, Chino (JP)

Correspondence Address: HARNESS, DICKEY & PIERCE, P.L.C., P.O. BOX 828, BLOOMFIELD HILLS, MI, 48303, US

(21) Appl. No.: 11/171,736

(22) Filed: Jun. 30, 2005

(30) Foreign Application Priority Data
Aug. 17, 2004 (JP) 2004-237244

(51) Int. Cl. G09G 3/36

(52) U.S. Cl. 345/100

(57) ABSTRACT

A source driver for driving a plurality of source lines of an electro-optic device, including a plurality of impedance conversion circuits each driving a respective one of the plurality of source lines in accordance with a grayscale voltage corresponding to display data; and a plurality of power save data storing circuits each storing power save data, wherein Each of the plurality of power save data storing circuits is provided for one of each of the plurality of impedance conversion circuits and a number of impedance conversion circuits, the number corresponding to the number of dots forming a pixel, each of the plurality of impedance conversion circuits includes a voltage follower circuit for driving one of the plurality of source lines and having a smaller phase margin without a load connected to an output thereof than with a load connected to the output thereof, and, an operating current of the voltage follower circuit included in the impedance conversion circuit is one of stopped and limited in accordance with the power save data stored in the power save data storing circuit corresponding to the impedance conversion circuit.

### BACKGROUND OF THE INVENTION

1. Technical Field

The present invention relates to a source driver, an electro-optic device using the same, and a driving method.

2. Related Art

In the related art, as liquid crystal panels (electro-optic devices) used for electronic apparatuses such as mobile phones, simple matrix liquid crystal panels and active matrix liquid crystal panels using switching elements such as thin film transistors (hereinafter abbreviated as TFT) are known.

The simple matrix method has an advantage that low power consumption can more easily be achieved compared to the active matrix method on the one hand, and has a disadvantage that multi-colored images or movies are difficult to be displayed on the other hand. In contrast, the active matrix method has an advantage that it is suitable for displaying multi-colored images or movies on the one hand, and has a disadvantage that low power consumption is difficult to be achieved on the other hand.

Further, in the recent years, needs for displaying multi-colored images or movies for portable electronic apparatuses such as mobile phones increase in order to provide high quality images. Accordingly, the simple matrix liquid crystal panels used in the related art have gradually been replaced with the active matrix liquid crystal panels.

Regarding the active matrix liquid crystal panel, impedance conversion circuits functioning as output buffers are provided in a source driver for driving source lines of the liquid crystal panel. In this case, some of the impedance conversion circuits not connected to the source lines of the liquid crystal panel are controlled so that the outputs thereof become high impedance. And, this control is executed for every block defined by dividing the source lines into a predetermined number of source lines.

Such related art is disclosed in Japanese Unexamined Patent Publication No. 2002-351413.

In general, the impedance conversion circuit includes an operational amplifier circuit (a voltage follower circuit) connected as a voltage follower, and is prevented from oscillating by inserting a capacitor for preventing oscillation in a path for feeding back the output.

However, if the capacitor for preventing oscillation is provided to the operational amplifier, it becomes difficult to shrink the circuit scale. In particular, if it is applied to the source driver as an output buffer, the operational amplifier is provided for each of, for example, 720 source lines, thus increasing the chip area and making the cost higher.

Further, the operational amplifier includes, for example, a differential amplifier and an output circuit. And, the reaction speed (response speed) of the output circuit is sometimes much faster than the reaction speed of the differential amplifier. In this case, the reaction speed of the output circuit drops as the load capacitance increases. As a result, the reaction speed of the differential amplifier and the reaction speed of the output circuit come closer to make the oscillation occur easier. The phenomenon means that the margin for avoiding the oscillation decreases because of increase in output load of the operational amplifier derived from increase in size of the liquid crystal panel.

Further, the capacitance value of the capacitor for preventing oscillation needs to be changed in accordance with the output load, and accordingly, if the capacitor is formed in the circuit, switching elements for trimming the capacitor are required, and moreover, the characteristic it self of the capacitor is also degraded.

As described above, taking the cost reduction and increase in the size of the liquid crystal panel into consideration, it is preferable to adopt the voltage follower circuit having smaller phase margin without load connected to the output than with the load connected to the output thereof. By thus arranged, the capacitor for preventing oscillation can be eliminated, and the oscillation can be prevented because the phase margin becomes larger as the output load becomes heavier with increased size of the liquid crystal panel.

Incidentally, when the electrical characteristics or the performance of the source driver including the impedance conversion circuits described above, it is difficult to execute examination by connecting testing loads to all the impedance conversion circuits. Because it merely increases the examination time to repeatedly execute the same examination for, for example, 720 impedance conversion circuits having the same circuit configurations. Therefore, the examination is executed by connecting the testing loads only to a part of the plurality of impedance conversion circuits.

However, in this case, the impedance conversion circuits not targeted for the examination remain without loads, and become easy to oscillate if the phase margins of the voltage follower circuits are small, as described above. And, if the voltage follower circuits included in the impedance conversion circuits not targeted for the examination oscillate, accurate current consumptions of the targeted impedance conversion circuits can not be evaluated, the targeted impedance conversion circuits having the power supply common to the impedance conversion circuits not targeted for the examination. Further, even if the outputs can be controlled to be high impedance for each block, the examination efficient in terms of cost and time is difficult because the examination needs to be executed for each block.

### SUMMARY

In view of the above technical problems, the present invention advantageously provides a source driver, an electro-optic device, and driving method capable of realizing not only cost reduction derived from shrinkage of the chip area but also reduction of the examination cost.

An aspect of the invention is a source driver for driving a plurality of source lines of an electro-optic device, including a plurality of impedance conversion circuits each driving a respective one of a plurality of source lines in accordance with a grayscale voltage corresponding to display data, and a plurality of power save data storing circuits each storing power save data. Each of the plurality of power save data storing circuits is provided for a respective one of the plurality of impedance conversion circuits. Each of the plurality of impedance conversion circuits includes a voltage follower circuit for driving one of the plurality of source lines and having a smaller phase margin without a load connected to an output thereof than with a load connected to the output thereof. Further, an operating current of the voltage follower circuit included in the impedance conversion circuit is inhibited or limited in accordance with the power save data stored in the power save data storing circuit corresponding to the impedance conversion circuit. Each of the plurality of power save data storing circuits can be provided for a number of impedance conversion circuits corresponding to a number of dots forming one pixel.

According to this aspect of the invention, as a voltage follower circuit included in the impedance conversion circuit for driving the source line in accordance with the grayscale voltage, what has a smaller phase margin when no load is connected to the output and has a larger phase margin when a load is connected to the output is adopted. Therefore, so-called the oscillation preventing capacitor can be eliminated, and drastic reduction of the circuit scale as well as speeding up of the output can be realized, and further, it can adapt to expansion of the display size of the electro-optic device.

In general, when evaluating the electric characteristics of performance of the source driver, only a part of impedance conversion circuits targeted for the evaluation are provided with loads and the outputs of the rest are left without connecting the loads. Therefore, if the voltage follower circuit according to the invention is adopted, the voltage follower circuit of the impedance conversion circuit not targeted for the examination becomes easier to oscillate, and it is difficult to accurately evaluate the electrical characteristics.

To cope with the problem, in an aspect of the invention, the power save data storing circuit for storing the power save data is provided for each impedance conversion circuit or for a number of impedance conversion circuits corresponding to the number of dots forming one pixel. And, in accordance with the power save data, the operating current of the voltage follower circuit included in the impedance conversion circuit is inhibited or limited for each impedance conversion circuit or for the number of impedance conversion circuits described above.

According to an aspect of the invention, the only impedance conversion circuits targeted for the evaluation can be set to the enabled states, as a result, the effects of the oscillation of the impedance conversion circuits not targeted for the evaluation can be prevented. As a result, a source driver including the impedance conversion circuits capable of eliminating the capacitor for preventing the oscillation and of being evaluated with high precision can be provided. Therefore, the source driver capable of realizing not only cost reduction derived from shrinkage of the chip area but also reduction of the cost for the examination can be provided.

Further, in the source driver according to another aspect of the invention, the plurality of power save data storing circuits is configured as a shift register having each of the plurality of power save data storing circuits connected in series, and the power save data can sequentially be set to the each of the plurality of power save data storing circuit by the shift operation.

According to this aspect of the invention, since the power save data can be set with a simple configuration, the source driver offering the above advantages can be provided with further low cost.

Further, the source driver according to still another aspect of the invention includes a display data memory storing the display data for each of the plurality of impedance conversion circuits and the power save data for each of the plurality of power save data storing circuits, the power save data can be read from the display data memory and can be set to each of plurality of power save data storing circuits.

According to this aspect of the invention, since the power save data can be set with a simple configuration, the source driver offering the above advantages can be provided with further low cost.

Further, in the source driver according to another aspect of the invention, a first power save data for setting the impedance conversion operation of an impedance conversion circuit group specified by designated two of the plurality of impedance conversion circuits to an enabled state is generated, and the first power save data is set to at least one of the plurality of power save data storing circuits or the display data memory.

Further, in the source driver according to still another aspect of the invention, a second power save data for setting the plurality of impedance conversion circuits other than the impedance conversion circuit group to a disabled state, in which an operating current of the voltage follower circuit is inhibited or limited, is generated, and the second power save data is set to at least one of the plurality of power save data storing circuits or the display data memory.

Further, in the source driver according to another aspect of the invention, each of the plurality of impedance conversion circuits further includes a resistor circuit connected in series between the voltage follower circuit and the output of the impedance conversion circuit, and the voltage follower circuit includes a differential section for amplifying the difference between the input signal and the output signal of the voltage follower circuit, and an output section for outputting the output signal of the voltage follower circuit in accordance with the output of the differential section, thus driving the source line via the resistor circuit.

In this aspect of the invention, the resistor circuit is provided to the output of the voltage follower circuit used generally for converting the infinitely high input impedance into a low impedance, and the source line is driven via the resistor circuit. By thus arranged, the slew rate (reaction speed) of the output section can be adjusted by the resistance value of the resistor circuit and the load capacitance of the source line. Therefore, a capacitor for phase compensation provided to the impedance conversion circuit for preventing oscillation determined by the relationship between the slew rate of the output of the differential section and the slew rate of the output of the output section whose output is fed back to the differential section can be eliminated.

Further, in the source driver according to still another aspect of the invention, a slew rate of the output of the differential section can be equal to or higher than a slew rate of the output of the output section.

According to this aspect of the invention, the phase margin of the impedance conversion circuit is small with no load connected while the slew rate of the output of the output section becomes small and the phase margin of the impedance conversion circuit becomes large when the load is connected. Therefore, by considering the phase margin when a load is not connected, oscillation can surely be prevented when a load is connected.

Further, an aspect of the invention relates to an electro-optic device including a plurality of source lines, a plurality of gate lines, a plurality of switching elements each connected to one of the plurality of source lines and one of the plurality of gate lines, a gate driver for scanning the plurality of gate lines, and the source driver described above for driving the plurality of source lines.

According to this aspect of the invention, an electro-optic device including a source driver capable of realizing not only cost reduction derived from shrinkage of the chip area but also reduction of the examination cost can be provided, thus the cost reduction of the electro-optic device can be realized.

Still another aspect of the invention relates to a driving method including the step of storing power save data to a power save data storing circuit provided for a voltage follower circuit for driving one of the plurality of source lines in accordance with a grayscale voltage corresponding to a display data, or a number of voltage follower, the number corresponding to the number of dots forming a pixel, and the step of inhibiting or limiting an operating current of the voltage follower circuit in accordance with the power save data stored in the power save data storing circuit provided for the voltage follower circuit, wherein the voltage follower circuit has a smaller phase margin with no load connected to the output thereof than with a load connected to the output thereof.

Further, the driving method according to another aspect of the invention, includes the step of generating a first power save data for setting the operation of a voltage follower circuit group to an enabled state, the voltage follower circuit group being specified by two of the plurality of voltage follower circuits each driving a source line; and the step of setting the first power save data to at least one of the plurality of power save data storing circuits.

Further, the driving method according to another aspect of the invention, includes the step of generating a second power save data for setting the voltage follower circuit group to a disabled state in which an operating current thereof is one of inhibited and limited, the voltage follower circuit group being specified by two of the plurality of voltage follower circuits each driving a source line, and the step of setting the second power save data to at least one of the plurality of power save data storing circuits.

### BRIEF DESCRIPTION OF THE DRAWINGS

The invention will now be described with reference to the accompanying drawings, wherein like numbers refer to like elements, and wherein:

FIG. 1 is a block diagram showing a schematic configuration of an electro-optic device applying a source driver according to the present embodiment.

FIG. 2 is a block diagram of a configuration example of a source driver according to the present embodiment.

FIG. 3 is a block diagram of a configuration example of a gate driver according to the present embodiment.

FIG. 4 is a configuration diagram of a substantial section of the source driver in a first configuration example of the present embodiment.

FIG. 5 is a diagram for explaining an example of a PS data setting method according to the first configuration example.

FIG. 6 is a circuit diagram showing a configuration example of a circuit for realizing a PS data setting method in the first configuration example.

FIG. 7 is a timing chart of an operational example of the circuit shown in FIG. 6.

FIG. 8 is a timing chart of an example of acquiring the PS data by the circuit shown in FIG. 6.

FIG. 9 is a configuration diagram of a substantial section of the source driver in a second configuration example of the present embodiment.

FIG. 10 is a block diagram showing a configuration example of a circuit for realizing a PS data setting method in the second configuration example.

FIG. 11 is a flowchart of an operational example of the circuit shown in FIG. 10.

FIG. 12 is a flowchart for explaining the operation shown in FIG. 11.

FIG. 13 is a flowchart for explaining the operation shown in FIG. 11.

FIG. 14 is a block diagram of a configuration example of an impedance conversion circuit according to the present embodiment.

FIG. 15 is a diagram for explaining a relationship between the oscillation and slew rates of a differential section and an output section shown in FIG. 14.

FIG. 16 is an explanatory diagram showing a variation example of an oscillation margin with respect to a load capacitance.

FIG. 17 is an explanatory diagram showing another variation example of an oscillation margin with respect to a load capacitance.

FIGS. 18A, 18B, and 18C are circuit diagrams each showing a configuration example of a resistor circuit.

FIG. 19 is a circuit diagram showing a configuration example of the voltage follower circuit shown in FIG. 14.

FIG. 20 is a diagram for explaining an operation of the voltage follower shown in FIG. 19.

FIG. 21 is a circuit diagram of a configuration example of a first current control circuit.

FIG. 22 is a circuit diagram of a configuration example of a second current control circuit.

FIG. 23 is a chart showing a simulation result of the voltage variations at nodes of a p-type differential amplifier circuit and a first auxiliary circuit.

FIG. 24 is a chart showing a simulation result of the voltage variations at nodes of an n-type differential amplifier circuit and a second auxiliary circuit.

FIG. 25 is a chart showing a simulation result of the voltage variations at output nodes.

FIG. 26 is a chart showing a simulation result of the variation of the phase margin and the gain variation of an operational amplifier without any loads.

FIG. 27 is a chart showing a simulation result of the variation of the phase margin and the gain variation of an operational amplifier with a load.

FIG. 28 is a circuit diagram of another configuration example of the voltage follower circuit shown in FIG. 14.

FIG. 29 is a circuit diagram for explaining an example of a configuration capable of reducing the operating current of a fourth current source.

### DESCRIPTION OF THE EMBODIMENTS

Hereinafter, an embodiment of the invention is described in detail with reference to the accompanying drawings. Note that the embodiment described below does not unreasonably limit the content of the invention as claimed in the claim section. Further, not all of the components of the configuration described below are essential elements of the invention.

1. Electro-Optic Device

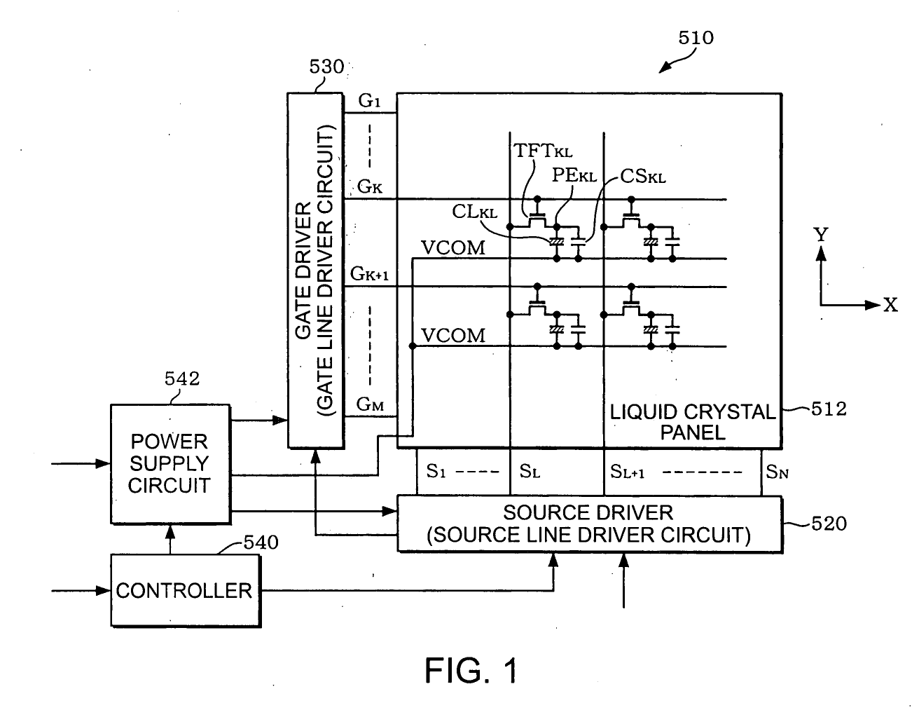

FIG. 1 shows an example of a block diagram of a display device including an electro-optic device applying the source driver according to the resent embodiment. In FIG. 1, a liquid crystal panel is adopted as the electro-optic device. In FIG. 1, the display device including the liquid crystal panel is defined as a liquid crystal device.

The liquid crystal device (a display device, in a broad sense) 510 includes a liquid crystal panel (an electro-optic device, in a broad sense) 512, a source driver (a source line driver circuit) 520, a gate driver (a gate line driver circuit) 530, a controller 540, and a power supply circuit 542. Note that the liquid crystal device 510 does not necessarily include all of these circuit blocks, but a configuration without a part of these circuit blocks can also be adopted.

Here, the liquid crystal panel 512 includes a plurality of gate lines (scanning lines, in a broader sense), a plurality of source lines (data lines, in a broader sense), and pixel electrodes specified by the gate lines and the source lines. In this case, an active matrix type of liquid crystal display device can be formed by connecting to the source line a thin film transistor TFT (in a broad sense, a switching element) connected to the pixel electrode.

More specifically, the liquid crystal panel 512 is formed on an active matrix substrate (e.g., a glass substrate). On the active matrix substrate, there are disposed gate lines G₁ through G_{M} (M denotes a natural number equal to or greater than two.) arranged in the Y direction in FIG. 1 and each extending in the X direction and source lines S₁ through S_{N} (N denotes a natural number equal to or greater than two.) arranged in the X direction and each extending in the Y direction. Further, a thin film transistor TFT_{KL} (in a broad sense, a switching element) is provided at a position corresponding to the intersection of the gate line G_{K} (1≦K≦M, K denotes a natural number.) and the source line S_{L}, (1≦L≦N, L denotes a natural number.).

The gate electrode of the TFT_{KL} is connected to the gate line G_{K}, the source electrode of the TFT_{KL} is connected to the source line S_{L}, and the drain electrode of the TFT_{KL} is connected to the pixel electrode PE_{KL}. A liquid crystal capacitance CL_{KL} (a liquid crystal element) and an auxiliary capacitance CS_{KL} are formed between the pixel electrode PE_{KL} and an opposing electrode VCOM (a common electrode) facing the pixel electrode PE_{KL} across a liquid crystal element (in a broad sense, an electro-optic material). And, the liquid crystal material is enclosed between the active matrix substrate, on which the TFT_{KL}, the pixel electrode PE_{KL}, and so on are formed, and the opposing substrate with the opposing electrode VCOM formed thereon so that the transmittance of the pixel changes in accordance with the voltage applied between the pixel electrode PE_{KL} and the opposing electrode VCOM.

Note that the electric potential applied to the opposing electrode VCOM is generated by the power supply circuit 542. Further, the opposing electrode VCOM is not necessarily formed over the surface of the opposing substrate, but can be formed like strips respectively corresponding to each of the gate lines.

The source driver 520 drives the source lines S₁ through S_{N} of the liquid crystal panel 512 in accordance with the display data (image data). Meanwhile, the gate driver 530 sequentially scans the gate lines G₁ through G_{M} of the liquid crystal panel 512.

The controller 540 can control the source driver 520, the gate driver 530, and the power supply circuit 542 based on the contents set by a host such as a central processing unit (CPU) not shown in the drawings.

More specifically, the controller 540 or the host supplies the source driver 520 with, for example, a configuration of an operational mode or a vertical sync signal and a horizontal sync signal generated inside thereof, and controls the power supply circuit 542 in a polarization reversing timing of the potential of the opposing electrode VCOM. The source driver 520 supplies the gate driver 530 with a gate driver control signal corresponding to a content set by the controller 540 or the host. The gate driver 530 is controlled in accordance with the gate driver control signal.

The power supply circuit 542 generates various voltages necessary for driving the liquid crystal panel 512 and the electric potential of the opposing electrode VCOM based on a reference voltage supplied externally.

Note that, although the liquid crystal device 510 has a configuration including the controller 540 in FIG. 1, the controller 540 can also be provided outside the liquid crystal device 510. Alternatively, the liquid crystal device 510 can include the host in combination with the controller 540. Further, a part or the whole of the source driver 520, the gate driver 530, the controller 540, and the power supply circuit 542 can be formed on the liquid crystal panel 512.

1.1 Source Driver

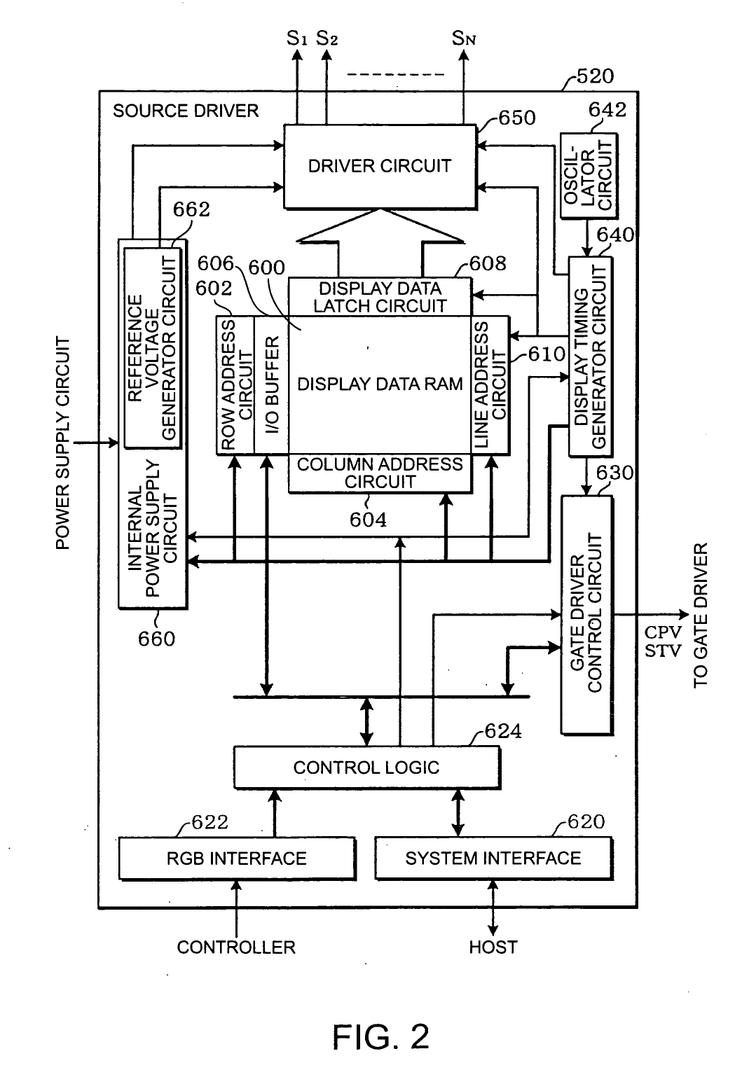

FIG. 2 shows a configuration example of the source driver 520 shown in FIG. 1.

The source driver 520 includes a display data RAM (Random Access Memory) 600 as a display data memory. The display data RAM 600 stores display data of still images or moving images. The display data RAM 600 is capable of storing at least one frame of display data. The host, for example, transfers display data of a still image directly to the source driver 520. Alternatively, the controller 540, for example, transfers display data of a moving image to the source driver 520.

The source driver 520 includes a system interface circuit 620 for interfacing with the host. Using the system interface circuit 620 performing interface processes of signals communicated with the host, the host can set control commands or display data of still images to the source driver 520, or read statuses of the source driver 520 or the display data RAM 600 via the system interface circuit 620.

The source driver 520 includes an RGB interface circuit 622 for interfacing with the controller 540. Using the RGB interface circuit 622 performing interface processes of signals communicated with the controller 540, the controller 540 can set display data of moving images to the source driver 520 via the RGB interface circuit 622.

The system interface circuit 620 and the RGB interface circuit 622 are connected to a control logic 624. The control logic 624 is a circuit block for managing the overall control of the source driver 520. The control logic 624 controls writing the display data input via the system interface circuit 620 or the RGB interface circuit 622 to the display RAM 600.

Further, the control logic 624 decodes the control commands input from the host via the system interface circuit 620, and controls various sections of the source driver 520 by outputting control signals corresponding to the decoding results. If the control command requires, for example, reading out from the display data RAM 600, it performs a process for reading out display data from the display data RAM 600 and outputting the display data to the host via the system interface circuit 620. Further, the control logic 624 also performs a control for setting power save (hereinafter abbreviated as PS) data mentioned below in accordance with a control command.

The source driver 520 includes a display timing generator circuit 640 and an oscillator circuit 642. The display timing generator circuit 640 generates timing signals for a display data latch circuit 608, a line address circuit 610, a driver circuit 650, and the gate driver circuit 630 based on a display clock signal generated by the oscillator circuit 642.

The gate driver control circuit 630 outputs the gate driver control signals (a clock signal CPV of one horizontal scanning period cycle, a starting pulse signal STV indicating the commencement of one vertical scanning period, a reset signal, and so on) for driving the gate driver 530 in accordance with the control commands input from the host via the system interface circuit 620.

A storage area of the display data RAM 600 to which the display data is stored is specified by a row address and a column address. The row address is designated by a row address circuit 602. The column address is designated by a column address circuit 604. The display data input via the system interface circuit 620 or the RGB interface circuit 622 is written to the storage area of the display data RAM 600 specified by the row address and the column address after being buffered by an I/O data buffer circuit 606. Further, the display data read out from the storage area of the display data RAM 600 specified by the row address and the column address is output via the system interface circuit 620 after being buffered by the I/O buffer circuit 606.

In sync with the clock signal CPV of one horizontal scanning period cycle of the gate driver control circuit 630, a line address circuit 610 designates a line address for reading out, from the display data RAM 600, the display data to be output to the driver circuit 650. The display data read out form the display data RAM 600 is output to the driver circuit 650 after being latched by a display data latch circuit 608.

The driver circuit 650 includes a plurality of driver output circuits each provided to respective one of the source lines. Each of the driver output circuits includes an impedance conversion circuit. The impedance conversion circuit includes a voltage follower circuit and drives the source line in accordance with a grayscale voltage corresponding to the display data from the display data latch circuit 608. The voltage follower circuit has a smaller phase margin without a load connected to the output thereof than with a load connected to the output thereof.

The source driver 520 includes an internal power supply circuit 660. The internal power supply circuit 660 generates a voltage necessary for liquid crystal displays using the power supply voltage supplied from the power supply circuit 542. The internal power supply circuit 660 includes a reference voltage generator circuit 662. The reference voltage generator circuit 662 generates a plurality of grayscale voltages obtained by dividing the difference between the higher potential side of power supply voltage VDD and the lower potential side of power supply voltage VSS. For example, if the display data for one dot is composed of six bits, the reference voltage generator circuit 662 generates 64 (=2⁶) kinds of grayscale voltages. Each of the grayscale voltages corresponds to the display data. And, in accordance with the digital display data from the display data latch circuit 608, the driver circuit 650 selects either one of the plurality of grayscale voltages generated by the reference voltage generator circuit 662, and then outputs the analogous grayscale voltage corresponding to the digital display data to the driver output circuit. And then, the impedance conversion circuit of the driver output circuit buffers the grayscale voltage to output it to the source line, thereby driving the source line. Specifically, the driver circuit 650 includes the impedance conversion circuit provided for each source line, and the voltage follower circuit of each impedance conversion circuit performs impedance conversion of the grayscale voltage to output it to respective source lines.

1. 2 Gate Driver

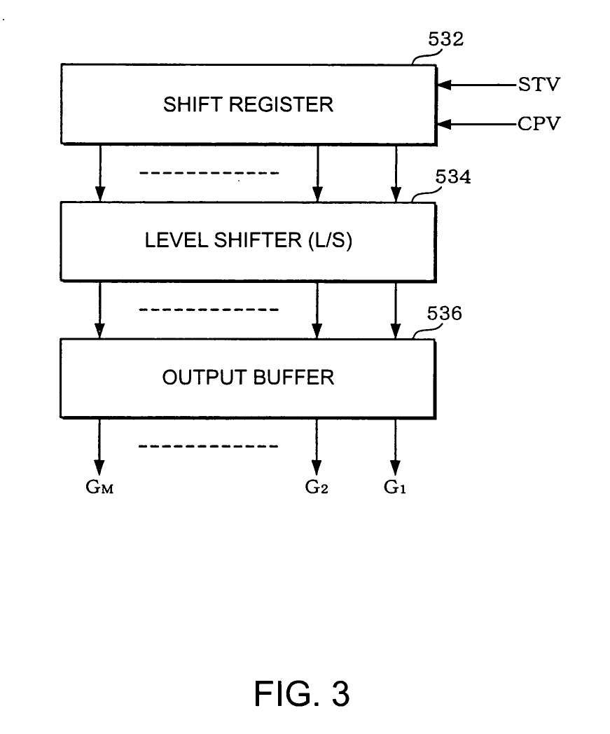

FIG. 3 shows a configuration example of the gate driver 530 shown in FIG. 1.

The gate driver 530 includes a shift register 532, a level shifter 534, and an output buffer 536.

The shift register 532 is provided correspondingly to each of the gate lines and includes a plurality of flip-flops connected in series. When the shift register 532 holds the start pulse signal STV in the flip-flop in sync with the clock signal CPV from the gate driver control circuit 630, the start pulse signal STV is then shifted sequentially to the adjacent flip-flops in sync with the clock signal CPV. The start pulse signal STV input here is a vertical sync signal from the gate driver control circuit 630.

The level shifter 534 shifts the voltage level of the shift register 532 to a voltage level suitable for the liquid crystal element of the liquid crystal panel 512 and the performance of the TFT as a transistor. As the voltage level, for example, a rather high voltage level of 20 through 50 volt is required.

The output buffer 536 buffers the scanning voltages shifted by the level shifter 534, outputs them to the gate lines to drive the gate lines.

2. Source Driver of the Present Embodiment

2. 1 First Configuration Example

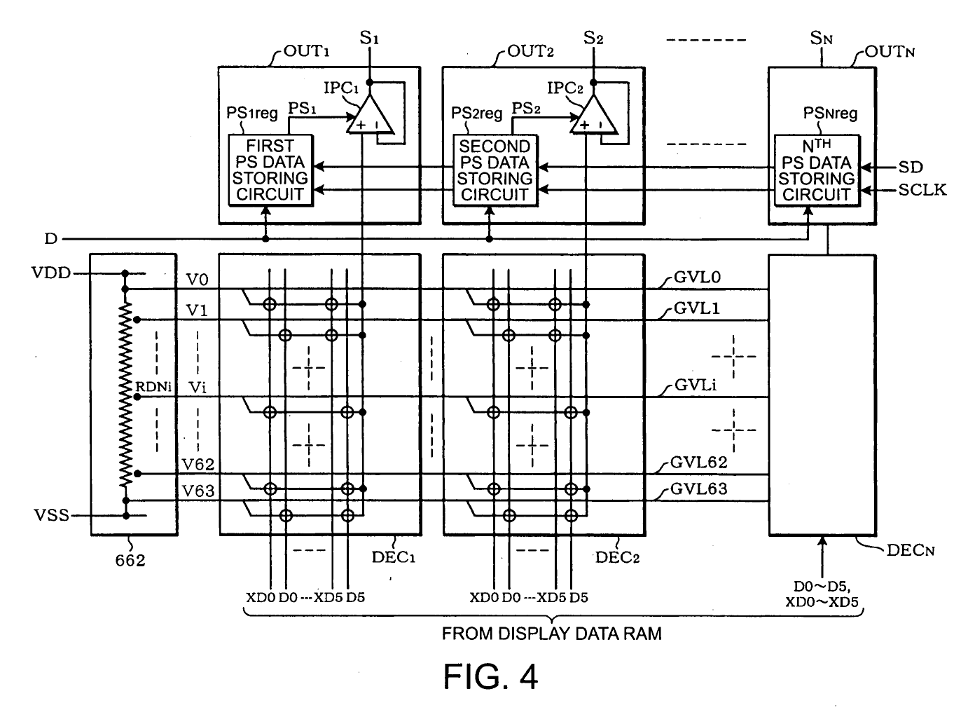

FIG. 4 is a configuration diagram of a substantial section of the source driver in a first configuration example of the present embodiment.

FIG. 4 shows a configuration example of the driver circuit 650 and the reference voltage generator circuit 662 shown in FIG. 3. Further, it is assumed that the display data for one dot is composed of six bits and the reference voltage generator circuit 662 generates the grayscale voltages V0 through V63.

The reference voltage generating circuit 662 additionally includes gamma correction resistors. The gamma correction resistors output a divided voltage Vi (0≦i≦63, i: an integer) obtained by resistively dividing the potential difference between the higher potential side of power supply voltage VDD and the lower potential side of power supply voltage VSS to a resistive division node RDNi as the grayscale voltage Vi. A grayscale voltage signal line GVLi is supplied with the grayscale voltage Vi.

The driver circuit 650 includes a plurality of driver output circuits OUT₁ through OUT_{N} each provided to respective one of the source lines. Each of the driver output circuits includes an impedance conversion circuit. The impedance conversion circuit includes the voltage follower circuit. The voltage follower circuit performs the impedance conversion operation in accordance with the grayscale voltage supplied to the input thereof to drive the source line connected to the output thereof. The voltage follower circuit includes a differential section and an output section. The differential section includes a differential amplifier composed of a metal oxide semiconductor (hereinafter abbreviated as MOS) transistor. It is arranged that the impedance conversion operation can be executed by making the operating current of the differential amplifier circuit flow, and the impedance conversion operation can be stopped by inhibiting or limiting the operating current.

The driver circuit 650 includes a first through an N^{th} decoders DEC₁ through DEC_{N}. Each of the first through the N^{th} decoders DEC₁ through DEC_{N} is provided in correspondence with the respective driver output circuits (the impedance conversion circuits, the voltage follower circuits). The display data D0 through D5 (including the inverted data XD0 through XD5 thereof) from the display data RAM 600 (in further detail, the display data latch circuit 608) is input to each of the decoders. Further, the grayscale voltage signal lines GVL0 through GVL63 from the reference voltage generator circuit 662 are connected to each of the decoders. And, each of the decoders selects one of the grayscale voltage signal lines corresponding to the display data D0 through D5, XD0 through XD5, and electrically connects the selected line to the input of the driver output circuit. By thus configured, the input of each of the impedance conversion circuits (each of the voltage follower circuits) can be supplied with the grayscale voltage selected by the decoder provided in accordance with the impedance conversion circuit (the voltage follower circuit).

Each of the driver output circuits includes a PS data storing circuit in addition to the impedance conversion circuit. Namely, the source driver 520 includes a plurality of impedance conversion circuits IPC₁ through IPC_{N} each driving respective one of a plurality of source lines S₁ through S_{N} in accordance with the respective grayscale voltages supplied in accordance with the display data, and a plurality of PS data string circuits PS₁reg through PS_{N}reg each provided to respective one of the plurality of impedance conversion circuits IPC₁ through IPC_{N} and storing the PS data.

Note that, although the PS data storing circuit is provided to each of the impedance conversion circuits (the voltage follower circuits) in FIG. 4, the invention is not limited to such a configuration. For example, the PS data storing circuit can be provided commonly to the impedance conversion circuits (voltage follower circuits) for a number of dots composing one pixel. In this case, if one pixel is composed of three dots of RGB, the one PS data storing circuit is provided commonly to the impedance conversion circuits (the voltage follower circuits) corresponding respectively to the R component, the G component, and the B component of the one pixel.

Here, the PS data storing circuit stores the PS data. The PS data is a data for enabling or disabling the impedance conversion operation of the impedance conversion circuit (the voltage follower circuit).

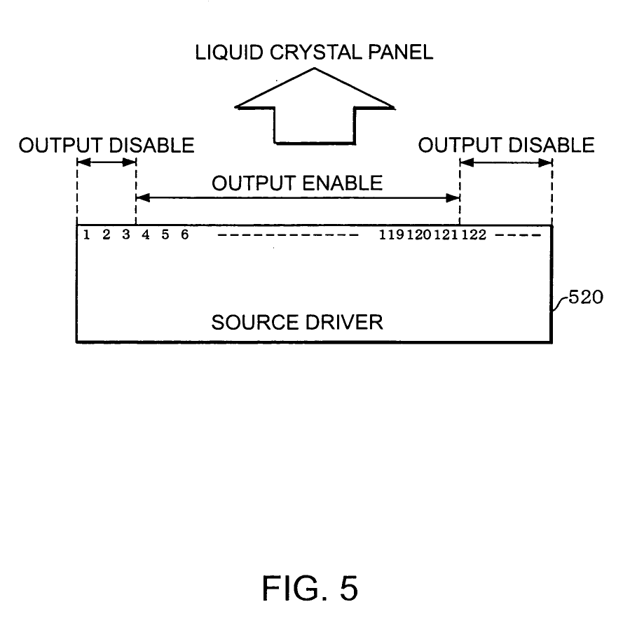

FIG. 5 shows a explanatory diagram for the PS data.

Here, the N outputs of the source driver 520 are schematically illustrated.

The impedance conversion circuits whose impedance conversion operations are set to the enabled states drive the source lines in accordance with the grayscale voltages. The impedance conversion circuits whose impedance conversion operations are set to the disabled states stop the impedance conversion operations by, for example, inhibiting or limiting the operating currents, and set the outputs to the high impedance states.

Accordingly, as shown in FIG. 5, if, for example, only the middle portion of the N outputs of the source driver 520 is enabled and the both edge portions thereof are disabled, the PS data stored in the PS data storing circuits provided correspondingly to the impedance conversion circuits to be enabled is set to, for example, “1,” while the PS data stored in the PS data storing circuits provided correspondingly to the impedance conversion circuits to be disabled is set to, for example, “0.” The voltage follower circuit of each of the impedance conversion circuits is controlled to stop the impedance conversion operation in accordance with the PS data stored in the PS data storing circuit provided correspondingly to the impedance conversion circuit. Namely, this means that a power saving control is cancelled in the impedance conversion circuits corresponding to the PS data storing circuits storing the PS data set to “1,” and the power saving control is executed in the impedance conversion circuits corresponding to the PS data storing circuits storing the PS data set to “0.”

By thus controlled, the impedance conversion circuits whose impedance conversion operations are stopped can be designated as precise as for one output or some outputs corresponding to the dots composing one pixel, thus realizing a precise power saving control.

Such a stopping control for the impedance conversion operation is preferably executed for every block composed of, for example, 8 pixels as an unit in general. However, in the present embodiment, the voltage follower circuit has a smaller phase margin without a load connected to the output thereof than with a load connected to the output thereof. Therefore, the capacitor for preventing the oscillation can be removed from the path for feeding back the output, and also the reaction speed of the output can be improved, but at the same time, it oscillates most easily without any loads connected to the output. Therefore, if an examination is executed with testing loads connected to a part of the plurality of impedance conversion circuits, the voltage follower circuits of the impedance conversion circuits not targeted for the examination are left without any loads, and accordingly, the voltage follower circuits of the impedance conversion circuits not targeted for the examination may oscillate with a high probability. If the voltage follower circuits oscillate, accurate current consumption or the like of the impedance conversion circuits targeted for the examination having the power supply in common thereto cannot be evaluated.

Therefore, it is arranged, as shown in FIG. 4, that the impedance conversion circuits whose impedance conversion operations are stopped can be designated as precise as for one output or some outputs corresponding to the dots composing one pixel. Thus, the only impedance conversion circuits targeted for the examination can be set to the enabled states, as a result, the effects of the oscillation of the impedance conversion circuits not targeted for the examination can be prevented. As a result, a source driver including the impedance conversion circuits capable of eliminating the capacitor for preventing the oscillation and of being evaluated with high precision can be provided. Therefore, the source driver capable of realizing not only cost reduction derived from shrinkage of the chip area but also reduction of the cost for the examination can be provided.

The PS data described above is preferably set in, for example, an initializing process. Further, if the PS data is changed while actually driving the liquid crystal panel, the change is preferably executed during so-called blank periods.

In the first configuration example, the plurality of PS data storing circuits PS₁reg through PS_{N}reg are configured as a shift register composed of the PS data storing circuits connected in series. The PS data is sequentially set to each of the PS data storing circuits by shifting operations. And, the PS data for setting to the enabled state the impedance conversion operations of the impedance conversion circuit group specified by two impedance conversion circuits designated in the plurality of impedance conversion circuits IPC₁ through IPC_{N} is generated, and is set to at least one of the plurality of power save data storing circuits PS₁reg through PS_{N}reg.

For example, in FIG. 5, if the impedance conversion circuits IPC₃ and IPC₁₂₁ are designated, the PS data for setting the impedance conversion circuits IPC₄ through IPC₁₂₁ to the enabled state is generated. In the first configuration example, the PS data for further setting the impedance conversion circuits IPC₁ through IPC₃ and IPC₁₂₂ through IPC_{N} to the disabled state is also generated, and then provided for the shifting operations as the shift data SD.

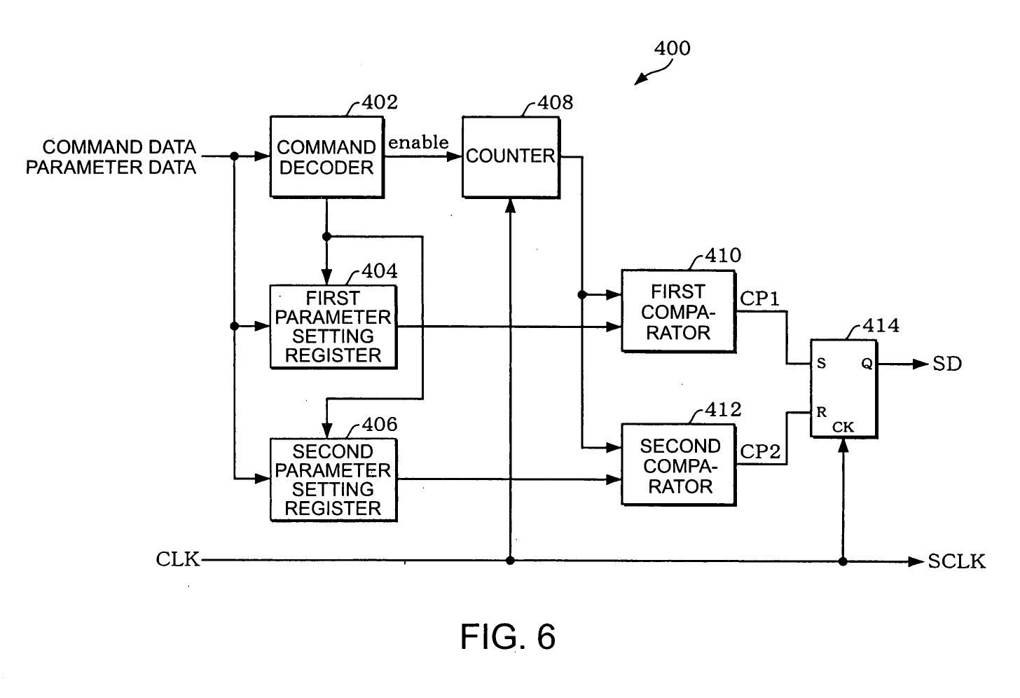

FIG. 6 shows a block diagram of a configuration example of a shift data generator circuit for realizing a PS data setting method in the first configuration example.

This shift data generator circuit 400 is included in, for example, the control logic 624 or the driver circuit 650 shown in FIG. 2, and capable of generating the shift data SD to be stored in the PS data storing circuits PS₁reg through PS_{N}reg forming the shift register.

The shift data generator circuit 400 includes a command decoder 402, a first and a second parameter setting registers, a counter 408, a first and a second comparators 410, 412, and a set-reset flip-flop (hereinafter abbreviated as FF) 414.

The command decoder 402 decodes the control commands from the host. The control commands from the host are input via the system interface circuit 620 shown in FIG. 2. If a first setting command previously provided as a control command for designating the PS data in the first configuration example is defined as one of the control commands, the first setting command has two parameters. The two parameters correspond to the data for designating the impedance conversion circuit group to be set to the enabled state. Further, the two parameters can be said to be the data for designating the impedance conversion circuits positioned at the borders between a group consisting of a series of enabled impedance conversion circuits arranged sequentially and a group consisting of a series of disabled impedance conversion circuits arranged sequentially.

If the command decoder 402 judges that the control command is the first setting command, it sets to the first and the second parameter setting registers 404, 406 the two parameter data input from the host in succession to the first setting command. And, the command decoder 402 outputs an enable signal “enable” to set the counter 408 to the enabled state.

The counter 408 counts up the count value in sync with the clock signal CLK in the enabled state. The clock signal CLK is used as the shift clock for realizing the shift operations of the plurality of PS data storing circuits PS₁reg through PS_{N}reg forming the shift register.

The first comparator 410 compares the value set in the first parameter setting register 404 with the count value of the counter 408, and outputs a matching pulse CP1 if the two values match each other. The second comparator 412 compares the value set in the second parameter setting register 406 with the count value of the counter 408, and outputs a matching pulse CP2 if the two values match each other.

The set-reset FF 414 is set by the matching pulse CP1 or reset by the matching pulse CP2 in sync with the clock signal CLK. The shift data SD is output from an output terminal Q of the set-reset FF 414.

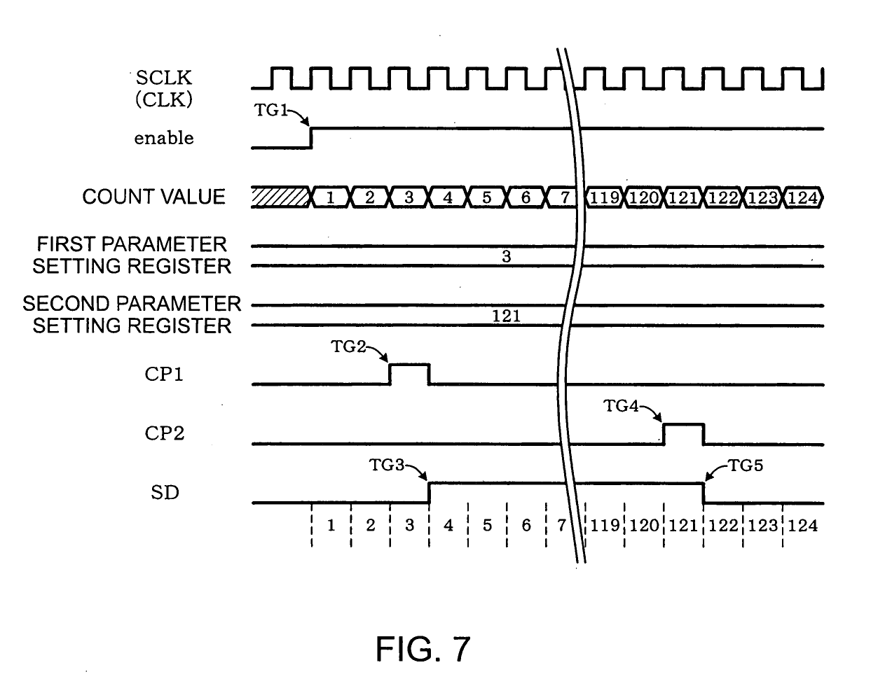

FIG. 7 shows a timing chart of an operational example of the shift data generator circuit shown in FIG. 6.

Here, the case is described in which the impedance conversion circuits IPC₄ through IPC₁₂₁ out of the impedance conversion circuits IPC₁ through IPC_{N} are set to the enabled state.

If the command decoder 402 judges that a control command is the first setting command after decoding the control command, the command decoder 402 sets the two parameter data (“3” designating the impedance conversion circuit IPC₃ and “121” designating the impedance conversion circuit IPC₁₂₁) input in succession to the first setting command to the first and the second parameter setting registers 404, 406 respectively, and activates the enable signal “enable” (TG1).

When the enable signal “enable” becomes active, the counter 408 starts incrementing the count value in sync with the clock signal CLK (the shift clock signal SCLK). And, when the count value reaches “3,” the count value matches the value set in the first parameter setting register 404, and accordingly, the first comparator 410 outputs the matching pulse CP1 (TG2). In this condition, the set-reset FF 414 is set in sync with the succeeding rising edge of the clock signal CLK, and shift data SD is changed to the H level (TG3).

Subsequently, when the count value reaches “121,” the count value matches the value set in the second parameter setting register 406, and accordingly, the second comparator 412 outputs the matching pulse CP2 (TG4). In this condition, the set-reset FF 414 is reset in sync with the succeeding rising edge of the clock signal CLK, and shift data SD is changed to the L level (TG5).

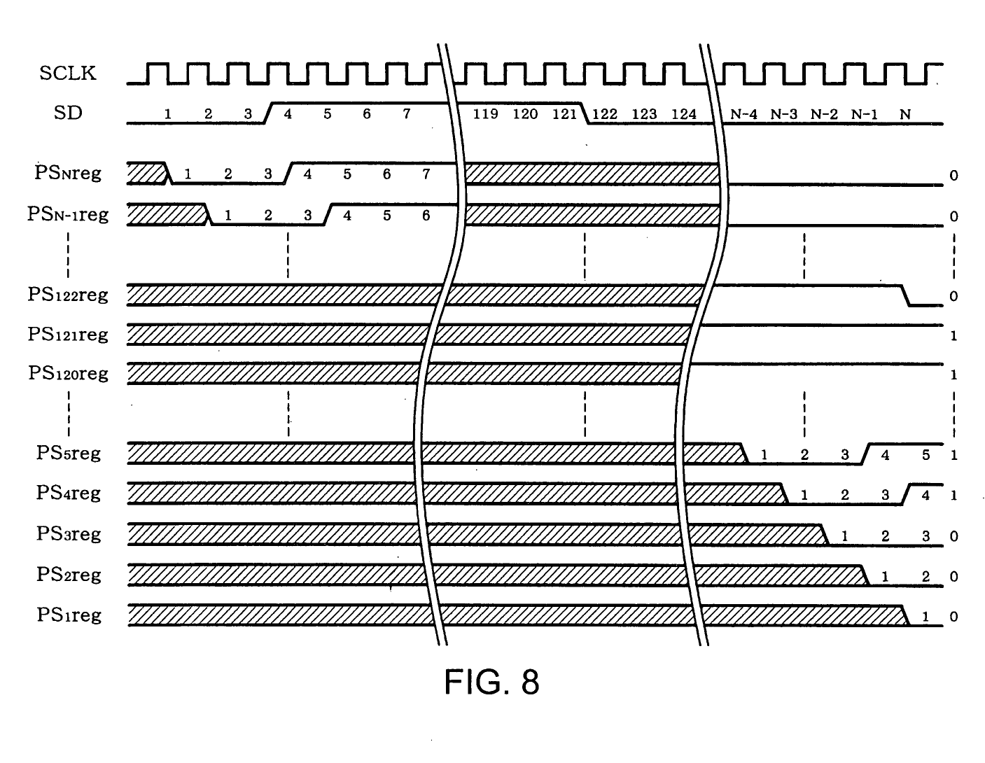

The shift data SD thus generated is set sequentially to the first through the N^{th} PS data storing circuits PS₁reg through PS_{N}reg in sync, for example, with the falling edges of the shift clock signal SCLK as shown in FIG. 8.

Note that the shifting operation or the shift direction is not limited to what is shown in FIGS. 4 through 8. Regarding the shifting operation, the first through the N^{th} PS data storing circuits PS₁reg through PS_{N}reg can commonly be connected to a data bus through which the shift data SD is supplied. Each of the PS data storing circuits is supplied with shift pulses for the shifting operation in sync with the shift clock signal SCLK. And, each of the PS data storing circuits can be arranged to acquire the shift data SD on the data bus in response to the shift pluses.

Note that in the configuration shown in FIG. 4, other than setting the PS data by the shifting operation commenced by the first setting command, the PS data can be arranged to be set directly to each of the PS data storing circuits in response to a second setting command. For example, when the command decoder 402 shown in FIG. 6 judged that the command from the host is the second command, the decoder acquires the parameter data input from the host in succession to the second setting command. According to the parameter, either one of the first through the N^{th} PS data storing circuits PS₁reg through PS_{N}reg is designated. Further, the PS data included in this parameter is supplied to the data bus D, and the PS data on the data bus D is set to the PS data storing circuit designated as described above. According to the second setting command, the PS data can directly be set only to the specified PS data storing circuit. Therefore, a part of the PS data can be changed without regenerating the shift data, thus simplifying the PS data setting operation.

2. 2 Second Configuration Example

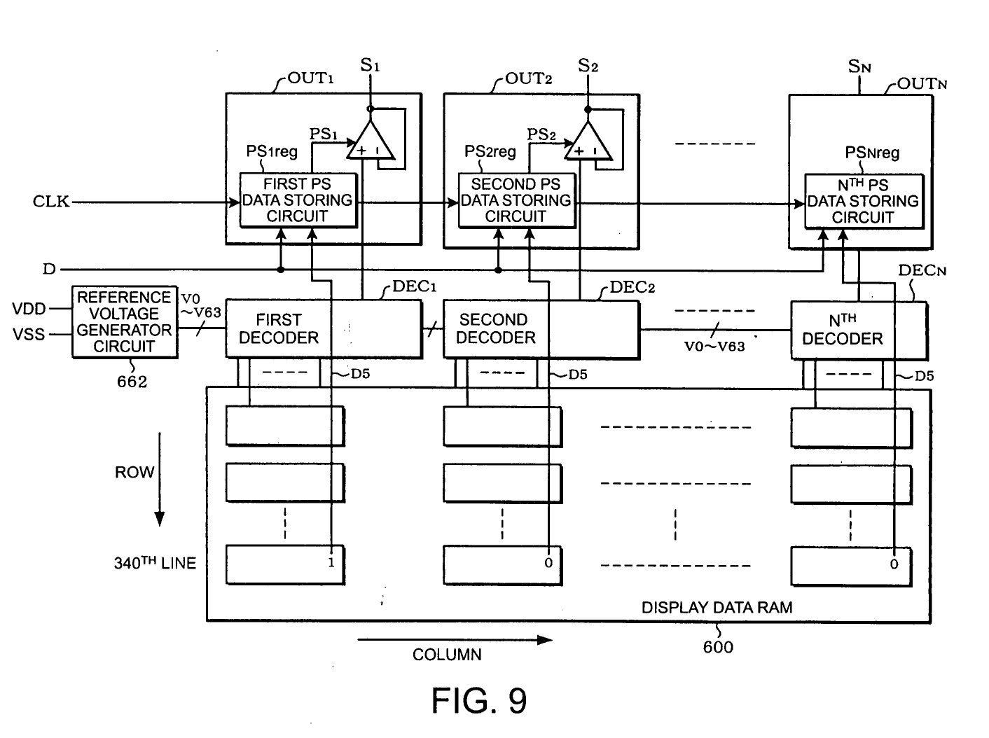

FIG. 9 is a configuration diagram of a substantial section of the source driver in a second configuration example of the present embodiment. Note that, in FIG. 9, the same sections as those in FIG. 4 are denoted with the same reference numerals and explanations therefor are omitted if appropriate.

In FIG. 9, configuration examples of the driver circuit 650, the reference voltage generator circuit 662, and the display data RAM 600 shown in FIG. 3 are illustrated, while the display data latch circuit 608 is omitted from the drawings. Further, as is the case with FIG. 4, it is assumed that the display data for one dot is composed of six bits and the reference voltage generator circuit 662 generates the grayscale voltages V0 through V63.

In the second configuration example, the PS data to be set to the first through the N^{th} PS data storing circuits PS₁reg through PS_{N}reg is temporarily set to the display data RAM 600. After then, the control logic 624 or the driver circuit 650 performs a control of reading it from the display data RAM 600 and then setting it to the first through the N^{th} PS data storing circuits PS₁reg through PS_{N}reg.

In the display data RAM 600, the display data of a horizontal scanning line of the liquid crystal panel 512 is stored in the storage area designated with the same row address. And, in this case, a predetermined storage area of the display data RAM 600 is commonly used for both the display data and the PS data. Assuming that the number of outputs of the source driver 520 is 240 multiplied by 3 (the number of dots for one pixel) and the number of lines in the maximum screen size for display is 340 lines, the storage area of the display data RAM 600 for the display data of the 340^{th} line is used commonly for the PS data. Assuming that the PS data necessary for one voltage follower circuit is one bit and the bit number of the display data for one dot is 6 (D0 through D5), the PS data is stored in the storage area for the most significant bit data of D5 of each of the display data of the 340^{th} line.

In this case, similar to the first configuration example, the PS data for setting to the enabled state the impedance conversion operations of the impedance conversion circuit group specified by two impedance conversion circuits designated in the plurality of impedance conversion circuits IPC₁ through IPC_{N} is generated, and is set to the storage area of the display data RAM described above.

For example, in FIG. 5, if the impedance conversion circuits IPC₃ and IPC₁₂₁ are designated, the PS data for setting the impedance conversion circuits IPC₄ through IPC₁₂₁ to the enabled state is generated. In the second configuration example, the PS data for further setting the impedance conversion circuits IPC₁ through IPC₃ and IPC₁₂₂ through IPC_{N} to the disabled state is also generated, and then set to the storage area of the display data RAM described above.

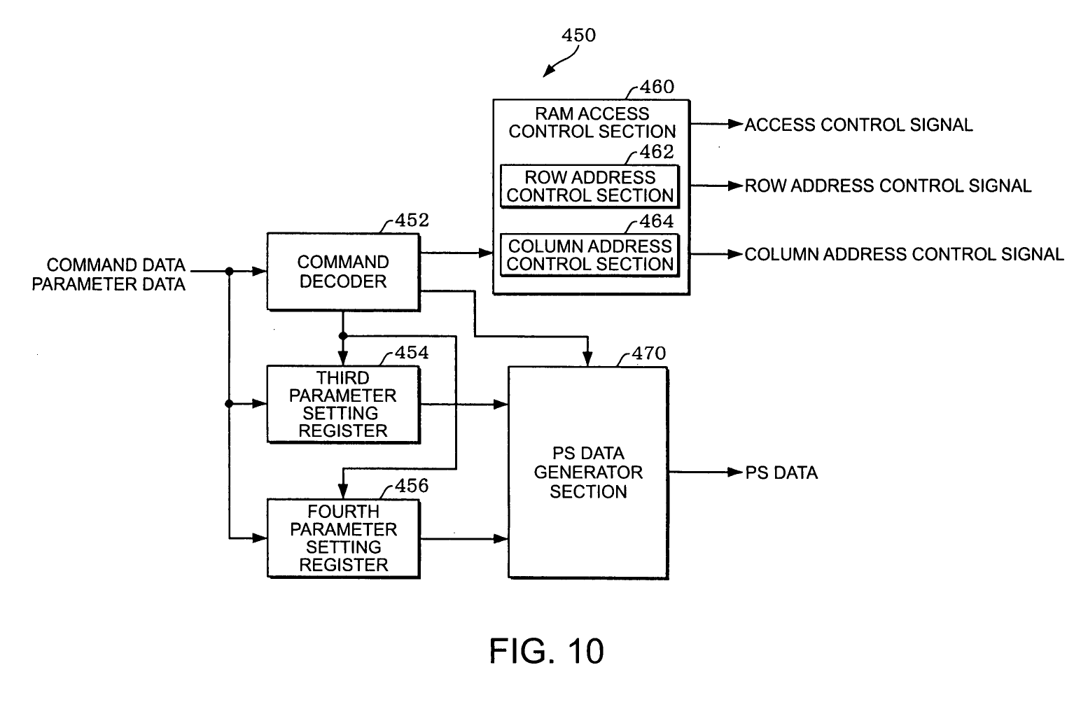

FIG. 10 shows a block diagram of a configuration example of a PS data setting circuit for realizing a PS data setting method in the second configuration example.

This PS data setting circuit 450 is included in, for example, the control logic 624 or the driver circuit 650 shown in FIG. 2.

The PS data setting circuit 450 includes a command decoder 452, a third and a fourth parameter setting register 454, 456, a RAM access control section 460, and a PS data generator section 470. The RAM access control section 460 includes a row address control section 462 and a column address control section 464. The row address control section 462 outputs to a row address circuit 602 a row address control signal for generating the row address of the display data RAM 600. The column address control section 464 outputs to a column address circuit 604 a column address control signal for generating the column address of the display data RAM 600.

The command decoder 452 decodes the control commands from the host. The control commands from the host are input via the system interface circuit 620 shown in FIG. 2. If a third setting command previously provided as a control command for designating the PS data in the second configuration example is defined as one of the control commands, the third setting command has two parameters. These two parameter data are the data for designating the impedance conversion circuits to be set to the enabled state, and are similar data to the parameter data set to the first and the second parameter setting registers 404, 406 in the first configuration example.

If the command decoder 452 judges that the control command is the third setting command, it sets to the third and the fourth parameter setting registers 454, 456 the two parameter data input from the host in succession to the third setting command. And, the command decoder 452 gives the RAM access control section 460 an instruction to access the display data RAM 600, and gives the PS data generator section 470 an instruction to generate the PS data.

The PS data generator section 470 is arranged to be able to generate the PS data in accordance with the values set in the third and the fourth parameter setting registers 454, 456. For example, if the PS data is set sequentially from the impedance conversion circuit IPC₁ through the impedance conversion circuit IPC_{N}, the PS data is set to “0” until the number of the impedance conversion circuit matches the value of the third parameter setting register 454, and the PS data is then set to “1” until the number of the impedance conversion circuit matches the value of the fourth parameter setting register 456. And then, after the number of the impedance conversion circuit matches the value set to the fourth parameter setting register 456, the PS data is reset to “0.”

The RAM access control section 460 outputs the access control signal, the row address control signal, and the column address control signal all for writing the PS data corresponding to the impedance conversion circuit, and the access signal and the row address control signal for reading out the PS data corresponding to the impedance conversion circuit.

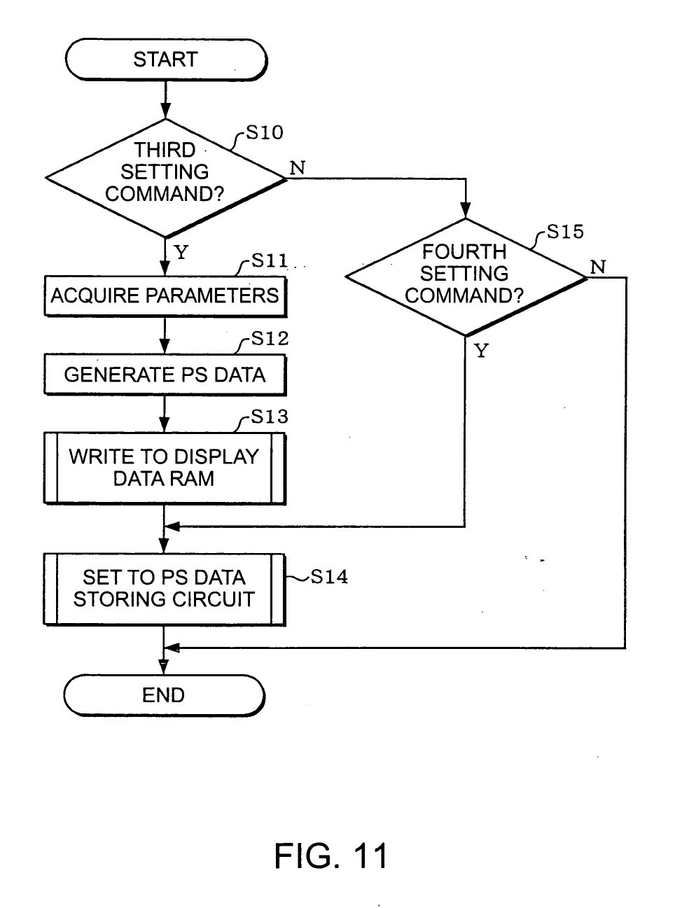

FIG. 11 shows a flowchart of an operational example of the PS data setting circuit 450 shown in FIG. 10.

Firstly, the command decoder 452 decodes the control command from the host. If the command decoder 452 judges that the control command is the third setting command (step S10: Y), the two parameter data input from the host in succession to the third setting command are acquired to the third and the fourth parameter setting register 454, 456 (step S11).

Subsequently, the command decoder 452 gives an instruction for generating the PS data to the PS data generator section 470. The PS data generator section 470 generates the PS data as, for example, described above in accordance with the values set in the third and the fourth parameter setting registers 454, 456 (step S12).

And then, the command decoder 452 gives an instruction for writing the PS data to the display data RAM 600 to the RAM access control section 460. Thus, the PS data is written to the display data RAM 600 (step S13).

After then, the command decoder 452 gives to the RAM access control section 460 an instruction for reading out the PS data written to the display data RAM 600, and sets the PS data read out from the display data RAM 600 to the respective PS data storing circuits (step S14) to terminate the series of processes (END).

If it is judged that the control command from the host is not the third setting command in the step S10 (step S10: N), then the command decoder 452 examines whether or not the control command is a fourth setting command previously defined as a control command for setting the PS data in the display data RAM to the first through the N^{th} PS data storing circuits PS₁reg through PS_{N}reg (step S15).

And then, if the command decoder 452 judges that the control command is the fourth setting command (step S15: Y), the control proceeds to the step S14. On the contrary, if the command decoder 452 judges that the control command is not the fourth setting command (step S15: N), the series of processes are terminated (END).

Note that in the second configuration example, since the PS data can be set from the host via the same path as the display data, the host can write the PS data to the display data RAM 600 in a similar way to the display data. In this case, by inputting the fourth setting command from the host, it can be judged that the most significant bit data of the 340^{th} line in the display data RAM 600 is the PS data, and accordingly, the data is acquired by the first through the N^{th} PS data storing circuits PS₁reg through PS_{N}reg.

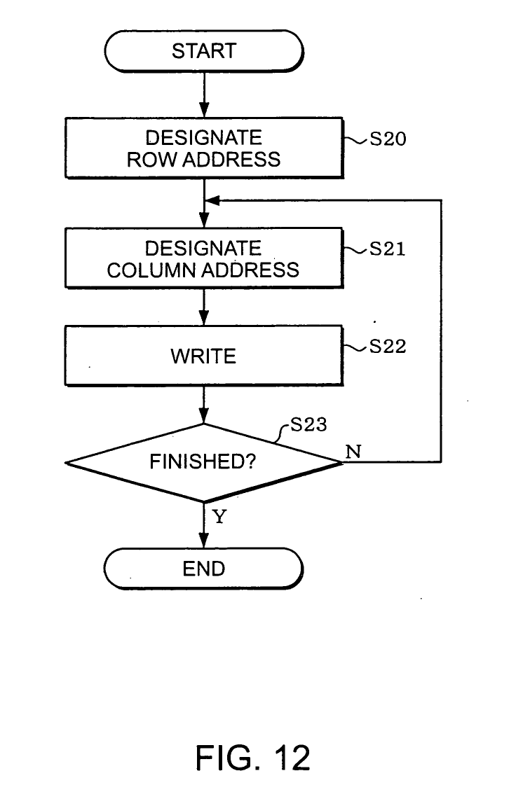

FIG. 12 shows a flowchart of a processing example of the step S13 shown in FIG. 11.

The RAM access control section 460, which receives from the command decoder 452 the instruction for writing the PS data, outputs the row address control signal in the row address control section 462. The row address circuit 602, in response to the row address control signal, generates the row address for specifying the storage area for the 340^{th} line of the display data shown in FIG. 9 (step S20).

Subsequently, the RAM access control section 460 outputs the column address control signal in the column address control section 464. The column address circuit 604, in response to the column address control signal, generates the column address for specifying the storage area for each column of the 340^{th} line of the display data shown in FIG. 9 (step S21). And, the RAM access control section 460 outputs the access control signal for writing to control writing of the PS data to the storage area specified by the row address designated in the step S20 and the column address designated in the step S21 (step S22).

If the writing process for all of the PS data generated by the PS data generator section 470 is not completed (step S23: N), the control goes back to the step S21 to output column address control signal for updating the column address.

If the writing process is thus completed (step S23: Y), the series of processes are terminated (END).

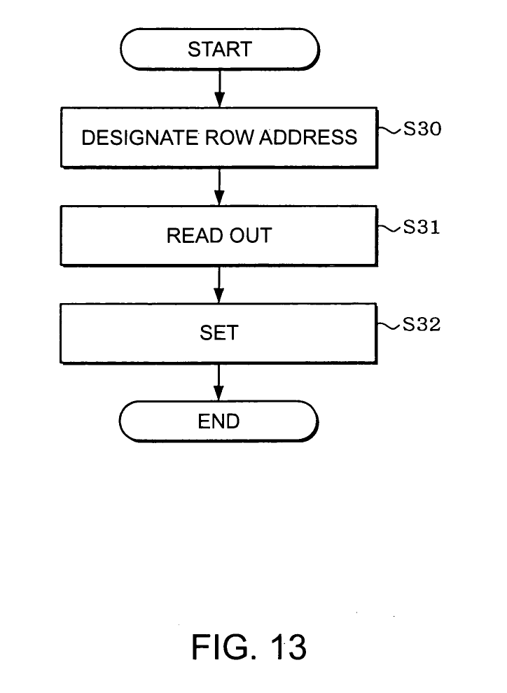

FIG. 13 shows a flowchart of a processing example of the step S14 shown in FIG. 11.

The RAM access control section 460, which receives from the command decoder 452 the instruction for setting the PS data, outputs the row address control signal in the row address control section 462. And then, the row address circuit 602 generates the row address for specifying the storage area for the 340^{th} line of the display data shown in FIG. 9 (step S30).

Subsequently, the RAM access control section 460 outputs the access control signal for reading out, and performs a control for reading out the PS data from the storage area specified by the row address designated in the step S30 (step S31).

Finally, the command decoder 452 outputs an instruction signal for acquiring the PS data read out in the step S31 to the first through the N^{th} PS data storing circuits PS₁reg through PS_{N}reg (step S32), and terminates the series of processes (END).

Note that, although the row address is designated in the explanation for the step S30, the line address for the 340^{th} line can alternatively be generated by the line address circuit 610 shown in FIG. 2. In this case, for example, the RAM access control section 460 includes the line address control section, and the line address control section outputs to the line address circuit 610 the line address control signal for generating the line address for the 340^{th} line.

3. Impedance Conversion Circuit

The impedance conversion circuit according to the present embodiment includes a voltage follower circuit having a smaller phase margin without a load connected to the output thereof than with a load connected to the output thereof. Hereinafter, such an impedance conversion circuit will be explained in detail.

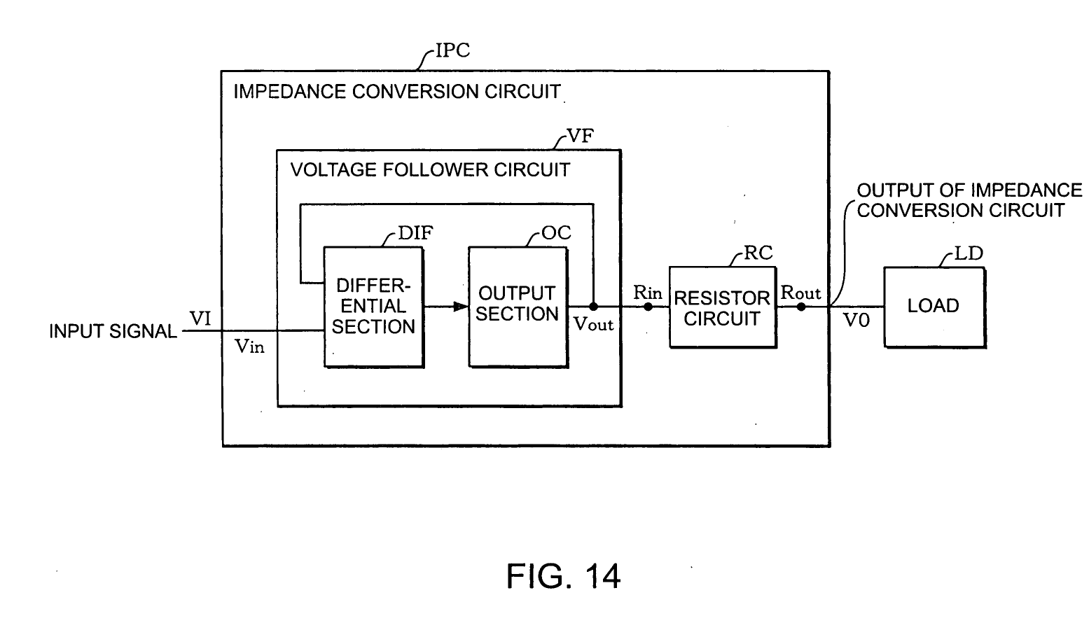

FIG. 14 shows a block diagram of a configuration example of the impedance conversion circuit according to the present embodiment. The impedance conversion circuit having a configuration shown in FIG. 14 is included in each of the driver output circuits shown in FIG. 4 or FIG. 9.

The impedance conversion circuit IPC includes the voltage follower circuit VF and a resistor circuit RC, and drives a capacitive load LD. The voltage follower circuit VF performs the impedance conversion of the input signal Vin (VI). The resistor circuit RC is connected in series between the voltage follower circuit VF and the output of the impedance conversion circuit IPC. And, the voltage follower circuit VF includes the differential section DIF for amplifying the difference between the input signal Vin (VI) and the output signal Vout of the voltage follower circuit VF, and the output section OC for outputting the output signal Vout based on the output of the differential section DIF.

Further, the impedance conversion circuit IPC drives the load LD connected to the output of the impedance conversion circuit via the resistor circuit RC. As described above, the resistor circuit RC is provided to the output of the voltage follower circuit VF used generally for converting the infinitely high input impedance into a low impedance, and the load LD is driven via the resistor circuit RC. By thus arranged, the slew rate (reaction speed) of the output section OC can be adjusted by the resistance value of the resistor circuit RC and the load capacitance of the load LD. Therefore, a capacitor for phase compensation provided to the voltage follower circuit VF (the impedance conversion circuit IPC) for preventing oscillation determined by the relationship between the slew rate of the output of the differential section DIF and the slew rate of the output of the output section OC whose output is fed back to the differential section DIF can be eliminated.

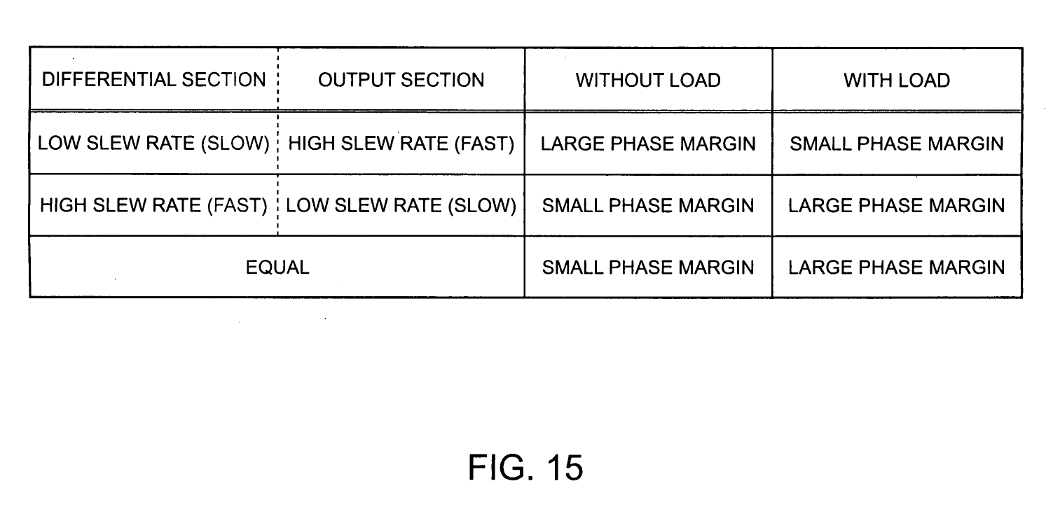

FIG. 15 is a diagram for explaining the relationship between the oscillation and the slew rates of the outputs of the differential section DIF and the output section OC. Here, the diagram is illustrated focusing on the relationship between the phase margin and the slew rates of the outputs of the differential section DIF and the output section OC.

The impedance conversion circuit IPC (the voltage follower circuit VF) oscillates with the phase margin of “0.” The larger the phase margin is, the more difficult to oscillate, and the smaller the phase margin becomes, the easier to oscillate. If the output of the output section OC is fed back to the input of the differential section DIF as is the case with the voltage follower circuit VF, the phase margin is determined by the slew rate (the reaction speed of the differential section DIF) of the output of the differential section DIF and the slew rate (the reaction speed of the output section OC) of the output of the output section OC.

Here, the slew rate of the output of the differential section DIF is a variation per unit time of the output of the differential section DIF in response to a step variation in the input to the differential section DIF. In FIG. 14, for example, it corresponds to the variation per unit time in the output of the differential section DIF that varies by amplifying the difference between the input signal Vin (VI) and the output signal Vout fed back from the output of the output section OC after the input signal Vin (VI) is input.

Further, the slew rate of the output of the differential section DIF can be considered by replacing with the reaction speed of the differential section DIF. In this case, the reaction speed of the differential section DIF corresponds to the time from when the input of the differential section DIF changes to when the output of the differential section DIF changes. In FIG. 14, for example, it corresponds to the time from when the input signal Vin (VI) is input to when the output of the differential section DIF is varied by amplifying the difference between the input signal Vin (VI) and the output signal Vout fed back from the output of the output section OC. The higher the slew rate is, the faster the reaction speed is, and the lower the slew rate is, the slower the reaction speed is. The reaction speed of the differential section DIF described above is determined by, for example, the current value of the current source of the differential section DIF.

Further, the slew rate of the output of the output section OC is a variation per unit time of the output thereof in response to a step variation in the input to the output section OC. In FIG. 14, it corresponds to the time from when the output of the differential section DIF varies to when the output signal Vout varies following the variation of the output of the differential section DIF.

Further, the slew rate of the output of the output section OC can be considered by replacing with the reaction speed of the output section OC. In this case, the reaction speed of the output section OC corresponds to the time from when the input of the output section OC changes to when the output of the output section OC changes. In FIG. 14, it corresponds to the time from when the output of the output section DIF varies to when the output signal Vout varies following the variation of the output of the differential section DIF. The reaction speed of the output section OC as described above is determined by, for example, the current drive capacity of the output section OC or a load connected to the output of the output section OC.

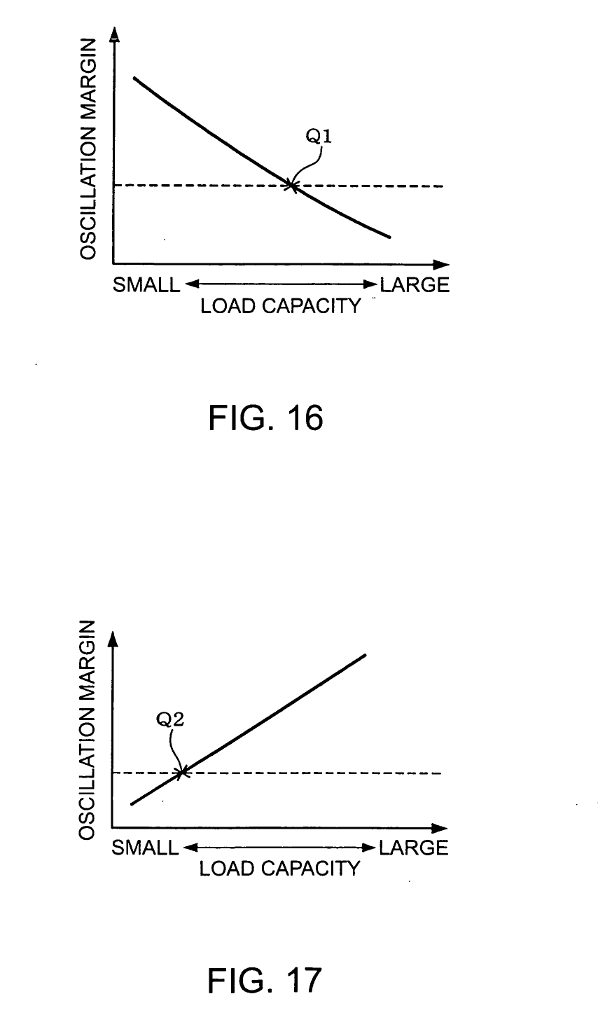

And, focusing on the stability of the output signal Vout, if the slew rate of the output of the differential section DIF gets close to the slew rate of the output of the output section OC, the oscillation can easily occur, which means that the phase margin becomes small. Therefore, if the slew rate of the output of the differential section DIF is lower than the slew rate of the output of the output section OC (the reaction speed of the differential section DIF is slower than the reaction speed of the output section OC), the phase margin is large in a load-unconnected state in which the load LD is not connected thereto. In this case, in a load-connected state, the slew rate of the output of the output section OC becomes lower to make the phase margin larger. Namely, as shown in FIG. 16, if the load capacity of the load LD becomes larger, an oscillation margin corresponding to the phase margin becomes smaller, and the oscillation occurs at the point Q1. In this case, if a sufficient amount of oscillation margin is provided in the load-unconnected state, the oscillation can be prevented in the load-connected state by considering the load capacity.

Further, if the slew rate of the output of the differential section DIF is higher than the slew rate of the output of the output section OC (the reaction speed of the differential section is faster than the reaction speed of the output section OC), the phase margin is small in the load-unconnected state. In this case, the slew rate of the output of the output section OC becomes smaller (the reaction speed of the output section OC becomes slower) in the load-connected state to make the phase margin larger. Further, if the slew rate of the output of the differential section DIF and the slew rate of the output of the output section OC are equal (equivalent) to each other, namely the reaction speed of the differential section is equal (substantially equivalent) to the reaction speed of the output section OC, the phase margin is small in the load-unconnected state, and in the load-connected state, the slew rate of the output of the output section OC becomes lower to make the phase margin larger. Therefore, as shown in FIG. 17, if the load capacitance of the load LD becomes larger, the oscillation margin becomes larger, and the oscillation occurs at the point Q2. However, by arranging the oscillation margin to become larger than the point Q2 in the load-unconnected state, the oscillation in the load-connected state can surely be prevented. The voltage follower circuit VF according to the present embodiment has a smaller oscillation margin in the load-unconnected state than in the load-connected state, and the heavier the load is, the larger the oscillation margin becomes.

3. 1 Resistor Circuit

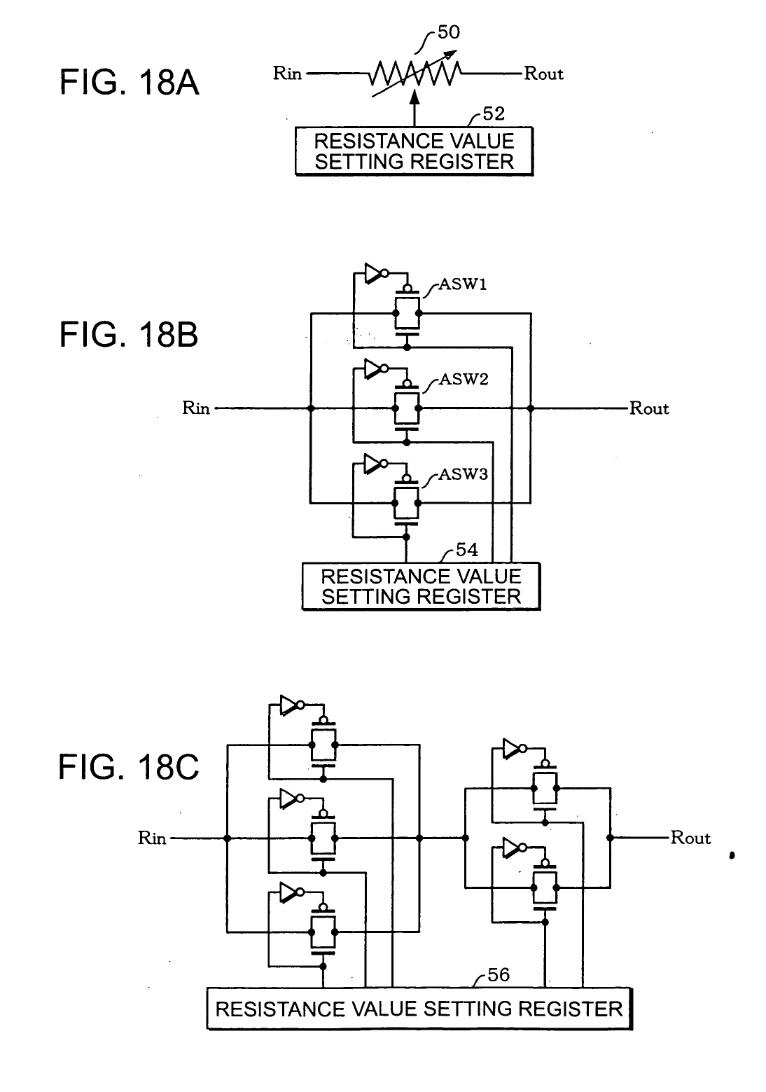

FIGS. 18A, 18B, and 18C show configuration examples of a resistor circuit.

The resistor circuit RC can include a variable resistor element 50 as shown in FIG. 18A. In this case, the slew rate of the output of the output section OC (the reaction speed of the output section OC) can be adjusted by the resistance value of the resistor circuit RC and the load capacitance value of the load LD. Note that a resistance value setting register 52 whose value can be set by the controller 540 or the host is preferably provided. And, it is preferable that the resistance value of the variable resistance element 50 can be set in accordance with the setting contents of the resistance value setting register 52.

Further, the resistor circuit RC can be composed of analog switch elements ASW as shown in FIG. 18B. In each of the analog switch elements ASW, the source and the drain of a p-type MOS transistor and the source and the drain of the n-type MOS transistor are respectively connected to each other. And, by switching on the p-type MOS transistor and the n-type MOS transistor simultaneously, the resistance value of the resistor circuit RC is determined based on the on-resistances of the p-type MOS transistor and the n-type MOS transistor.

More specifically, the resistor circuit RC can include a plurality of analog switches connected in parallel to each other. Although the three analog switch elements ASW1 through ASW3 are connected in parallel in FIG. 18B, two or more than three analog switch elements can be connected in parallel. In FIG. 18B, it is preferable that the resistance values of the analog switch elements are differently set by varying the sizes of the transistors forming the analog switch elements. By thus configured, variations of the resistance value realized by the resistor circuits RC can be enhanced by switching on at least one of analog switch elements ASW1 through ASW3.

Note that a resistance value setting register 54 whose value can be set by the controller 540 or the host is preferably provided. Further, it is preferable that on or off of the analog switch elements ASW1 through ASW3 can be set in accordance with the setting contents of the resistance value setting register 54.

Furthermore, the resistor circuit RC can be configured so that a number of analog switch units are connected in series, the analog switch unit being composed of a plurality of analog switch elements connected in parallel, as shown in FIG. 18C. In this case, a resistance value setting register 56 whose value can be set by the controller 540 or the host is preferably provided. Further, it is preferable that on or off of the analog switch elements can be set in accordance with the setting contents of the resistance value setting register 56.

And, if the resistor circuit RC as shown in FIGS. 18A through 18C are adopted, it is preferable that the larger the capacitance of the load LD is, the smaller the resistance value of the resistor circuit is set to be, and the smaller the capacitance of the load LD is, the larger the resistance value of the resistor circuit is set to be. This is because, since the time for charging the load is determined in accordance with the product of the resistance value of the resistor circuit and the load capacitance value, the gain becomes small if a substantial amount of oscillation margin is assured.

3. 2 Voltage Follower Circuit

In the present embodiment, as described above, the stability of the circuit can be determined by the relative relationship between the slew rate of the output of the differential section DIF and the slew rate of the output of the output section OC. As shown in FIG. 15, the slew rate of the output of the differential section DIF is preferably equal to or higher than the slew rate of the output of the output section OC.

By adopting the voltage follower circuit having a configuration described below, a configuration capable of improving the slew rate of the output of the differential section DIF as well as eliminating the capacitor for phase compensation.

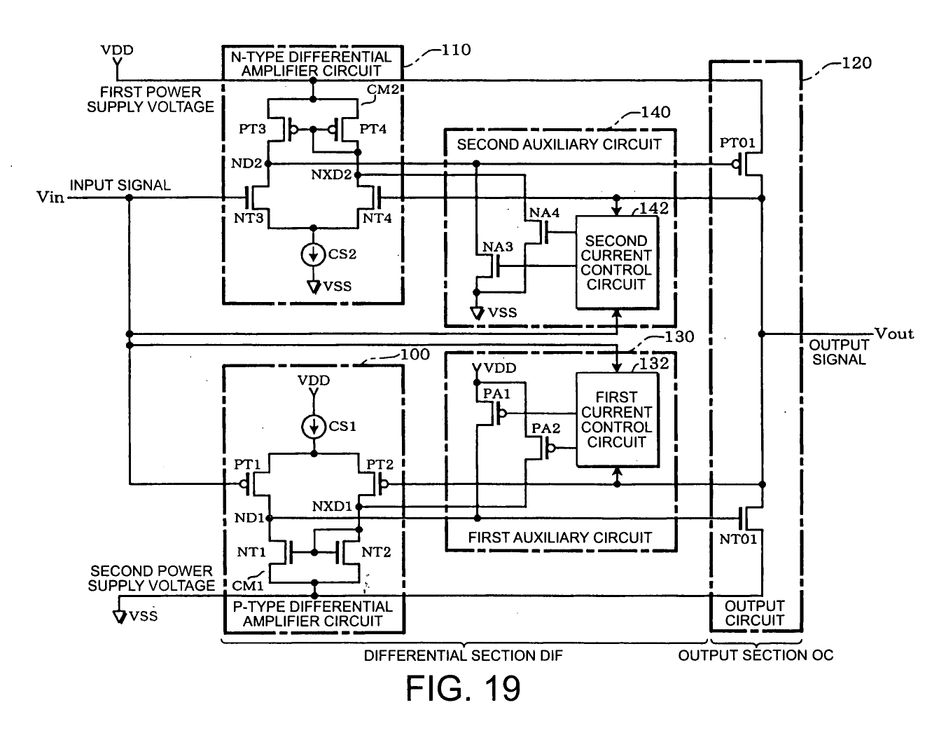

FIG. 19 shows a configuration example of the voltage follower circuit VF in the present embodiment.

The differential section DIF of the voltage follower circuit VF includes a p-type (e.g., a first conductivity type) differential amplifier circuit 100 and an n-type (e.g., a second conductivity type) differential amplifier circuit 110. The output section OC of the voltage follower circuit VF includes output circuit 120. The p-type differential amplifier circuit 100, the n-type differential amplifier circuit 110, and the output circuit 120 have the operational voltages between a higher potential side VDD (in a broad sense, a first power supply voltage) of the power supply voltages and a lower potential side VSS (in a broad sense, a second power supply voltage) of the power supply voltages.

The p-type differential amplifier circuit 100 amplifies the difference between the input signal Vin and the output signal Vout. The p-type differential amplifier circuit 100 has an output node ND1 (a first output node) and an inverted output node NXD1 (a first inverted output node), and outputs, between the output node ND1 and the inverted output node NXD1, a voltage corresponding to the difference between the input signal Vin and the output signal Vout.

The p-type differential amplifier circuit 100 has a first current mirror circuit CM1 and a first differential pair of p-type (a first conductivity type) transistors. The first differential pair of transistors includes p-type MOS transistors (Hereinafter, a MOS transistor is simply referred to as a transistor.) PT1, PT2. The source of each of the p-type transistors PT1, PT2 is connected to a first current source CS1 while the input signal Vin and the output signal Vout are respectively supplied to the gates of the transistors. The drain currents of the p-type transistors PT1, PT2 are generated by the first current mirror circuit CM1. The input signal Vin is supplied to the gate of the p-type transistor PT1. The output signal Vout is supplied to the gate of the p-type transistor PT2. The drain of the p-type transistor PT1 becomes the output node ND1 (the first output node). The drain of the p-type transistor PT2 becomes the inverted output node NXD1 (the first inverted output node).

The n-type differential amplifier circuit 110 amplifies the difference between the input signal Vin and the output signal Vout. The n-type differential amplifier circuit 110 has an output node ND2 (a second output node) and an inverted output node NXD2 (a second inverted output node), and outputs, between the output node ND2 and the inverted output node NXD2, a voltage corresponding to the difference between the input signal Vin and the output signal Vout.

The n-type differential amplifier circuit 110 has a second current mirror circuit CM2 and a second differential pair of n-type (a second conductivity type) transistors. The second differential pair of transistors includes n-type transistors NT3, NT4. The source of each of the n-type transistors NT1, NT2 is connected to a second current source CS2 while the input signal Vin and the output signal Vout are respectively supplied to the gates of the transistors. The drain currents of the n-type transistors NT3, NT4 are generated by the second current mirror circuit CM2. The input signal Vin is supplied to the gate of the n-type transistor NT3. The output signal Vout is supplied to the gate of the n-type transistor NT4. The drain of the n-type transistor NT3 becomes the output node ND2 (the second output node). The drain of the n-type transistor NT4 becomes the inverted output node NXD2 (the second inverted output node).

The output circuit 120 generates the output signal Vout based on the voltage of the output node ND1 (the first output node) of the p-type differential amplifier circuit 100 and the voltage of the output node ND2 (the second output node) of the n-type differential circuit 110.

The output circuit 120 includes an n-type (the second conductivity type) first driver transistor NTO1 and a p-type (the first conductivity type) second driver transistor PTO1. The gate (voltage) of the first driver transistor NTO1 is controlled based on the voltage of the output node ND1 (the first output node) of the p-type differential amplifier circuit 100. The gate (voltage) of the second driver transistor PTO1 is controlled based on the voltage of the output node (ND2) (the first output node) of the n-type differential amplifier circuit 110. The drain of the second driver transistor PTO1 is connected to the drain of the first driver transistor NTO1. And, the output circuit 120 outputs the voltage of the drain of the first driver transistor NTO1 (the voltage of the drain of the second driver transistor PTO1) as the output signal Vout.

Further, the voltage follower circuit VF of the present embodiment can eliminate the dead zone, prevent the through current, and quickly charge the gate voltages of the first and the second drive transistors PTO1, NTO2 by including the first and the second auxiliary circuits 130, 140, thus speeding up the differential section DIF. As a result, the low power consumption as well as speeding up can be realized by suppressing the through current without unnecessarily expanding the range of the operational voltage.

Note that the first auxiliary circuit 130 drives at least one of the output node ND1 (the first output node) and the inverted output node NXD1 (the first inverted output node) of the p-type differential amplifier circuit 100 in accordance with the input signal Vin and the output signal Vout. Further, the second auxiliary circuit 140 drives at least one of the output node ND2 (the second output node) and the second inverted output node (NXD2) of the n-type differential amplifier circuit 110 in accordance with the input signal Vin and the output signal Vout.

And, when the absolute value of the voltage between the gate and the source of the p-type transistor PT1 (the transistor composing the first differential pair of transistors and having the gate to which the input signal Vin is supplied) is smaller than the absolute value of the threshold voltage of the p-type transistor PT1, the first auxiliary circuit 130 controls the gate voltage of the first driver transistor NTO1 by driving at least one of the output node ND1 (the first output node) and the inverted output node NXD1 (the first inverted output node).

Further, when the absolute value of the voltage between the gate and the source of the n-type transistor NT3 (the transistor composing the second differential pair of transistors and having the gate to which the input signal Vin is supplied) is smaller than the absolute value of the threshold voltage of the r-type transistor NT3, the second auxiliary circuit 140 controls the gate voltage of the second driver transistor PTO1 by driving at least one of the output node ND2 (the second output node) and the inverted output node NXD2 (the second inverted output node).

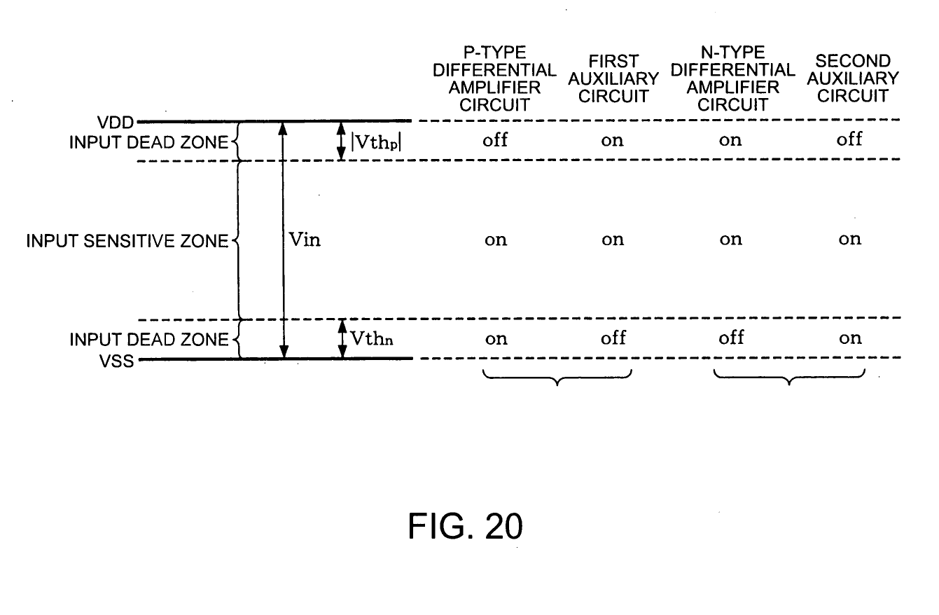

FIG. 20 shows a diagram for explaining an operation of the voltage follower circuit VF shown in FIG. 19.

Note that the higher potential side of the power supply voltages is denoted with VDD, the lower potential side of the power supply voltages is denoted with VSS, the input signal voltage is denoted with Vin, the threshold voltage of the p-type transistor PT1 is denoted with Vthp, and the threshold voltage of the n-type transistor NT3 is denoted with Vthn.

If the following inequality is true, the p-type transistor is in the off-state while the n-type transistor is in the on-state.
VDD≧Vin>VDD−|Vthp|
Note that, when the p-type transistor operates in the cut-off region, the linear region, or the saturation region in accordance with the gate voltage, the off-state of the p-type transistor means that the p-type transistor is in the cut-off region. Likewise, when the n-type transistor operates in the cut-off region, the linear region, or the saturation region in accordance with the gate voltage, the on-state of the n-type transistor means that the n-type transistor is in the linear region or the saturation region. Accordingly, if the following inequality is true, the p-type differential amplifier circuit 100 does not operate (off-state) while the n-type differential amplifier circuit 110 operates (on-state).
VDD≧Vin>VDD−|Vthp|
Then, the first auxiliary circuit 130 is switched on to start its operation (to drive at least one of the output node ND1 (the first output node) and the inverted output node NXD1 (the first inverted output node)), the second auxiliary circuit 140 is switched off to stop its operation (to stop driving both of the output node ND2 (the second output node) and the inverted output node NXD1 (the second inverted output node)). As described above, it can be avoided that the voltage of the output node ND1 becomes an indefinite state even when the input signal Vin is in the input dead zone of the first differential pair of transistors of the p-type differential amplifier circuit 100 by driving the output node ND1 of the p-type differential amplifier circuit 100 by the first auxiliary circuit 130 within a range in which the p-type differential amplifier circuit 100 does not operate.

If the following inequality is true, the p-type transistor is in the on-state while the n-type transistor is in the off-state.
VDD−|Vthp|≧Vin≧Vthn+VSS
Note that, when the p-type transistor operates in the cut-off region, the linear region, or the saturation region in accordance with the gate voltage, the on-state of the p-type transistor means that it is in the linear region or the saturation region. Therefore, the p-type differential amplifier circuit 100 operates (on-state) while the n-type differential amplifier circuit 110 also operates (on-state). In this case, the operation of the first auxiliary circuit 130 is switched on or off while the operation of the second auxiliary circuit 140 is switched on or off. Namely, since the p-type differential amplifier circuit 100 and the n-type differential amplifier circuit 110 operate, the output nodes ND1, ND2 can be prevented from becoming indefinite state, but output the output signal Vout by the output circuit 120. Therefore, the first and the second auxiliary circuits 130, 140 can be operated or stopped. In FIG. 20, the operations are switched on.

If the following inequality is true, the p-type transistor is in the on-state while the n-type transistor is in the off-state. Vthn+VSS≧Vin≧VSS Note that, when the n-type transistor operates in the cut-off region, the linear region, or the saturation region in accordance with the gate voltage, the off-state of the n-type transistor means that it is in the cut-off region. Therefore, the n-type differential amplifier circuit 110 does not operate (off-state) while the p-type differential amplifier circuit 100 operates (on-state). Then, the second auxiliary circuit 140 is switched on to start its operation (to drive at least one of the output node ND2 (the second output node) and the inverted output node NXD2 (the second inverted output node)), the first auxiliary circuit 130 is switched off to stop its operation. As described above, it can be avoided that the voltage of the output node ND2 becomes an indefinite state even when the input signal Vin is in the input dead zone of the second differential pair of transistors of the n-type differential amplifier circuit 110 by driving the output node ND2 (the inverted output node NXD2) of the n-type differential amplifier circuit 110 by the second auxiliary circuit 140 within a range in which the n-type differential amplifier circuit 110 does not operate.

As described above, according to the first and the second auxiliary circuits 130, 140, the gate voltages of the first and the second driver transistors NTO1, PTO1 forming the output circuit 120 become controllable, thus eliminating unnecessary through current caused by the input signal whose voltage is in the range of the input dead zone. Moreover, by eliminating the input dead zone of the input signal Vin, it becomes needless to provide the offset voltage in consideration of the variations of the threshold voltage Vthp of the p-type transistor and the threshold voltage Vthn of the n-type transistor. Therefore, since the voltage follower circuit VF can be formed using the voltage between the higher potential side VDD of the power supply voltages and the lower potential side VSS of the power supply voltages as the amplitude, the range of the operational voltage can be narrowed without degrading the driving capacity, thus further reducing the power consumption. This means implementation of the step-up circuit or a lower withstand voltage of the manufacturing process, thus realizing the cost reduction.

And, since the output nodes ND1, ND2 are driven by the first and the second auxiliary circuits 130, 140, speeding up of the reaction speed of the differential section DIF can be realized, and the phase compensation capacitors can also be eliminated. Further, by commonly degrading the current drive capacities of the first and the second driver transistors PTO1, NTO1 of the output section OC, the reaction speed of the output section OC can be slowed.

A detailed configuration example of the voltage follower circuit VF according to the present embodiment is hereinafter described.

In FIG. 19, the p-type differential amplifier circuit 100 includes the first current source CS1, the first differential pair of transistors described above, and the first current mirror circuit CM1. One end of the first current source CS1 is supplied with the higher potential side VDD (the first power supply voltage) of the power supply voltages. The other end of the first current source CS1 is connected to the sources of the p-type transistors PT1, PT2 forming the first differential pair of transistors described above.

The first current mirror circuit CM1 includes the first pair of n-type (the second conductivity type) transistors whose gates are connected to each other. The first pair of transistors includes n-type transistors NT1, NT2. The sources of the n-type transistors NT1, NT2 are supplied with the lower potential side VSS (the second power supply voltage) of the power supply voltages. The drain of the n-type transistor NT1 is connected to the output node ND1 (the first output node). The drain of the n-type transistor NT2 is connected to the inverted output node NXD1 (the first inverted output node). The drain and the gate of the n-type transistor NT2 (the transistor forming the first differential pair of transistors and being connected to the inverted output node NXD1) are connected to each other.

Further, the n-type differential amplifier circuit 110 includes the second current source CS2, the second differential pair of transistors described above, and the second current mirror circuit CM2. One end of the second current source CS2 is supplied with the lower potential side VSS (the second power supply voltage) of the power supply voltages. The other end of the second current source CS2 is connected to the sources of the n-type transistors NT3, NT4 forming the second differential pair of transistors described above.

The second current mirror circuit CM2 includes the second pair of p-type (the first conductivity type) transistors whose gates are connected to each other. The second pair of transistors includes p-type transistors PT3, PT4. The sources of the p-type transistors PT3, PT4 are supplied with the higher potential side VDD (the first power supply voltage) of the power supply voltages. The drain of the p-type transistor PT3 is connected to the output node ND2 (the second output node). The drain of the p-type transistor PT4 is connected to the inverted output node NXD2 (the second inverted output node). The drain and the gate of the p-type transistor PT4 (the transistor forming the second differential pair of transistors and being connected to the inverted output node NXD2) are connected to each other.

Further, the first auxiliary circuit 130 can include the p-type (the first conductivity type) of a first and a second current driver transistors PA1, PA2, and a first current control circuit 132. The sources of the first and the second current driver transistors PA1, PA2 are supplied with the higher potential side VDD (the first power supply voltage) of the power supply voltages. The drain of the first current driver transistor PA1 is connected to the output node ND1 (the first output node). The drain of the second current driver transistor PA2 is connected to the inverted output node NXD1 (the first inverted output node).

And, the first current control circuit 132 controls the gate voltages of the first and the second current driver transistors PA1, PA2 in accordance with the input signal Vin and the output signal Vout. More specifically, when (the absolute value of) the voltage between the gate and the source of the p-type transistor PT1 composing the first differential pair of transistors and having the gate to which the input signal Vin is supplied is smaller than (the absolute value of) the threshold voltage of the transistor, the first current control circuit 132 controls the gate voltages of the first and the second current driver transistors PA1, PA2 to drive at least one of the output node ND1 (the first output node) and the inverted output node NXD1 (the first inverted output node).

Further, the second auxiliary circuit 140 can include the n-type (the second conductivity type) of a third and a forth current driver transistors NA3, NA4, and a second current control circuit 142. The sources of the third and the fourth current driver transistors NA3, NA4 are supplied with the lower potential side VSS (the second power supply voltage) of the power supply voltages. The drain of the third current driver transistor NA3 is connected to the output node ND2 (the second output node). The drain of the fourth current driver transistor NA4 is connected to the inverted output node NXD2 (the second inverted output node).

And, the second current control circuit 142 controls the gate voltages of the third and the fourth current driver transistors NA3, NA4 in accordance with the input signal Vin and the output signal Vout. More specifically, when the absolute value of the voltage between the gate and the source of the n-type transistor NT3 composing the second differential pair of transistors and having the gate to which the input signal Vin is supplied is smaller than the absolute value of the threshold voltage of the transistor, the second current control circuit 142 controls the gate voltages of the third and the fourth current driver transistors NA3, NA4 to drive at least one of the output node ND2 (the second output node) and the inverted output node NXD2 (the second inverted output node).

In FIG. 19, the reaction speed of the differential section DIF corresponds to the time from when the input signal Vin changes to when the gate voltages of the first and the second driver transistor PTO1, NTO1 change to reach a predetermined level. Further, the reaction speed of the output section OC corresponds to the time from when the gate voltages of the first and the second driver transistor PTO1, NTO1 change to when the output signal Vout changes to reach a predetermined level.

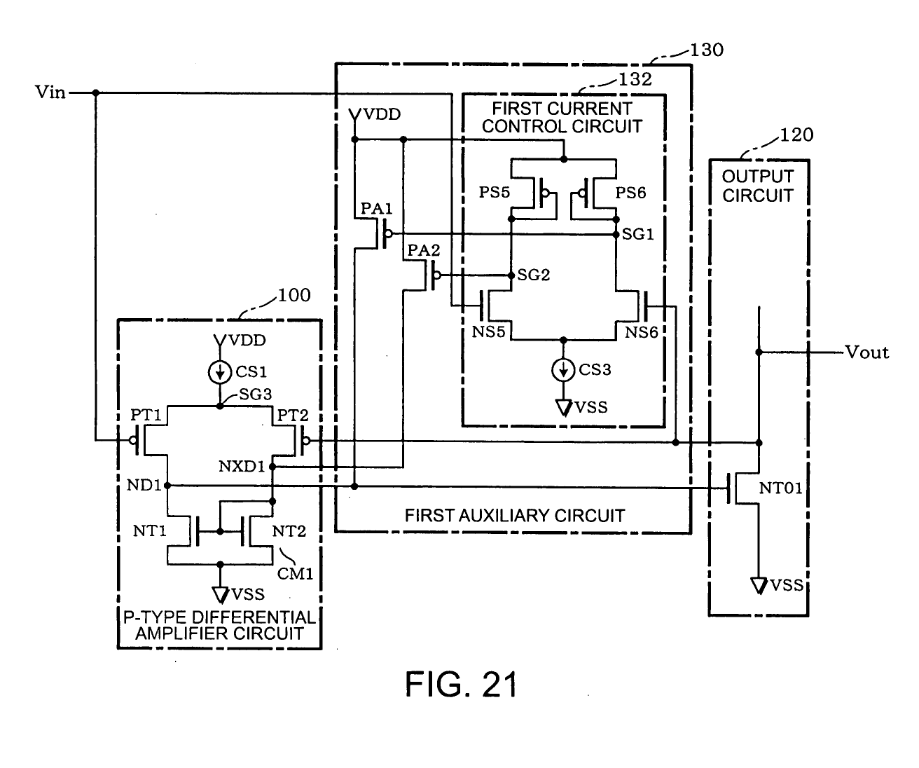

FIG. 21 shows a configuration example of the second current control circuit 132 shown in FIG. 1. Note that the same parts as those of the voltage follower circuit VF shown in FIG. 19 are denoted with the same reference numerals and explanations therefor are omitted if appropriate.

The first current control circuit 132 includes the third current source CS3, a third differential pair of transistors of the n-type (the second conductivity type), a fifth and a sixth current driver transistors PS5, PS6 of the p-type (the first conductivity type).

One end of the third current source CS3 is supplied with the lower potential side VSS (the second power supply voltage) of the power supply voltages.

The third differential pair of transistors includes n-type transistors NS5, NS6. The sources of the n-type transistors NS5, NS6 are connected to the other end of the third current source CS3. The input signal Vin is supplied to the gate of the n-type transistor NS5. The output signal Vout is supplied to the gate of the n-type transistor NS6.

The sources of the fifth and the sixth current driver transistors PS5, PS6 are supplied with the higher potential side VDD (the first power supply voltage) of the power supply voltages. The drain of the fifth current driver transistor PS5 is connected to the drain of the n-type transistor NS5 forming the third differential pair of transistors. The drain of the sixth current driver transistor PS6 is connected to the drain of the n-type transistor NS6 forming the third differential pair of transistors. The gate and the drain of the fifth current driver transistor PS5 are connected to each other. The gate and the drain of the sixth current driver transistor PS6 are connected to each other.

And, the drain of the n-type transistor NS5 (the transistor forming the third pair of differential transistors and having a gate to which the input signal Vin is supplied) forming the third differential pair of transistors (or the drain of the fifth current driver transistor PS5) is connected to the gate of the second current driver transistor PA2. Further, the drain of the n-type transistor NS6 (the transistor forming the third pair of differential transistors and having a gate to which the output signal Vout is supplied) forming the third differential pair of transistors (or the drain of the sixth current driver transistor PS6) is connected to the gate of the first current driver transistor PA1.

Namely, the first and the sixth current driver transistors PA1, PS6 compose a current mirror circuit. Similarly, the second and the fifth current driver transistors PA2, PS5 compose a current mirror circuit.

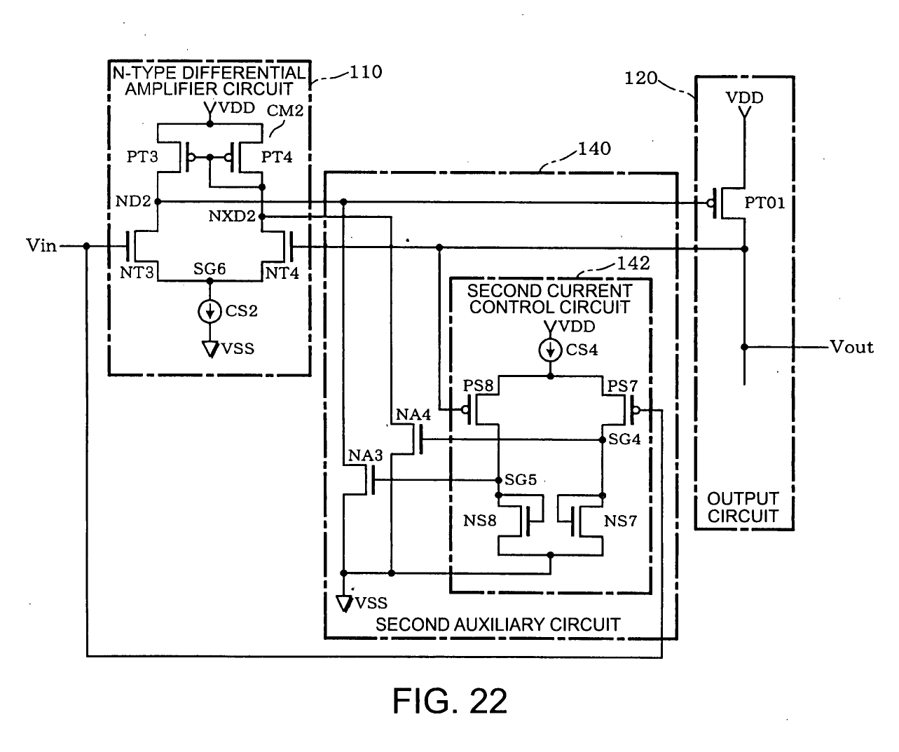

FIG. 22 shows a configuration example of the second current control circuit 142 shown in FIG. 2. Note that the same parts as those of the voltage follower circuit VF shown in FIG. 19 are denoted with the same reference numerals and explanations therefor are omitted if appropriate.

The second current control circuit 142 includes the fourth current source CS4, a fourth differential pair of transistors of the p-type (the first conductivity type), a seventh and a eighth current driver transistors NS7, NS8 of the n-type (the second conductivity type).

One end of the fourth current source CS4 is supplied with the higher potential side VDD (the first power supply voltage) of the power supply voltages.

The fourth differential pair of transistors includes p-type transistors PS7, PS8. The sources of the p-type transistors PS7, PS8 are connected to the other end of the fourth current source CS4. The input signal Vin is supplied to the gate of the p-type transistor PS7. The output signal Vout is supplied to the gate of the p-type transistor PS8.

The sources of the seventh and the eighth current driver transistors NS7, NS8 are supplied with the lower potential side VSS (the second power supply voltage) of the power supply voltages. The drain of the seventh current driver transistor NS7 is connected to the drain of the p-type transistor PS7 forming the fourth differential pair of transistors. The drain of the eighth current driver transistor NS8 is connected to the drain of the p-type transistor PS8 forming the fourth differential pair of transistors. The gate and the drain of the seventh current driver transistor NS7 are connected to each other. The gate and the drain of the eighth current driver transistor NS8 are connected to each other.

And, the drain of the p-type transistor PS7 (the transistor forming the fourth pair of differential transistors and having a gate to which the input signal Vin is supplied) forming the fourth differential pair of transistors (or the drain of the seventh current driver transistor NS7) is connected to the gate of the fourth current driver transistor NA4. Further, the drain of the p-type transistor PS8 (the transistor forming the fourth pair of differential transistors and having a gate to which the output signal Vout is supplied) forming the fourth differential pair of transistors (or the drain of the eighth current driver transistor NS8) is connected to the gate of the third current driver transistor NA3.

Namely, the third and the eighth current driver transistors NA3, NS8 compose a current mirror circuit. Similarly, the fourth and the seventh current driver transistors NA4, NS7 compose a current mirror circuit.

The voltage follower circuit VF having a configuration shown in FIG. 19 is hereinafter described assuming that the first auxiliary circuit 130 comprises the first current control circuit 132 shown in FIG. 21 and that the second auxiliary circuit 140 comprises the second current control circuit 142 having a configuration shown in FIG. 22.

Firstly, if the following inequality is true, although the p-type differential amplifier circuit 100 operates properly with the p-type transistor PT1 switched on, the voltages of the nodes of the n-type differential amplifier circuit 110 become indefinite because the n-type transistor NT3 does not operate.
Vthn+VSS≧Vin>VSS

At this point, focusing on the second auxiliary circuit 140, since the p-type transistor PS7 is switched on to lower its impedance, the gate voltage of the fourth current driver transistor NA4 rises. As a result, the impedance of the fourth current driver transistor NA4 is lowered. Therefore, the fourth current driver transistor NA4 drives the inverted output node NXD2 to pull in the current, thus lowering the potential of the inverted output node NXD2. As a result, the impedance of the p-type transistor PT3 is lowered to raise the potential of the output node ND2. And, the impedance of the second driver transistor PTO1 in the output circuit 120 rises to lower the potential of the output signal Vout. Thus, the impedance of the p-type transistor PS8 is lowered to raise the gate voltage of the third current driver transistor NA3. Accordingly, the impedance of the third current driver transistor NA3 is lowered to lower the potential of the output node ND2.

In this way, the result of raising the potential of the output node ND2 by lowering the impedance of the p-type transistor PT3 is fed back, and the potential of the output node ND2 is lowered by lowering the impedance of the third current driver transistor NA3. As a result, an equilibrium state is made, in which the voltage of the input signal Vin and the voltage of the output signal Vout are substantially the same, the gate voltage of the second driver transistor PTO1 is determined to the most appropriate level.

Incidentally, when the following inequality is true, they operate in the reverse way.
VDD≧Vin>VDD−|Vthp|
Namely, although the n-type differential amplifier circuit 110 operates properly with the n-type transistor NT3 switched on, the voltages of the nodes of the p-type differential amplifier circuit 100 become indefinite because the p-type transistor PT1 does not operate.

At this point, focusing on the first auxiliary circuit 130, since the n-type transistor NS5 is switched on to lower its impedance, the gate voltage of the second current driver transistor PA2 is lowered. As a result, the impedance of the second current driver transistor PA2 is lowered. Therefore, the second current driver transistor PA2 drives the inverted output node NXD1 to supply the current, thus raising the potential of the inverted output node NXD1. As a result, the impedance of the n-type transistor NT2 is lowered to lower the potential of the output node ND1. And, the impedance of the first driver transistor NTO1 in the output circuit 120 rises to raise the potential of the output signal Vout. Thus, the impedance of the n-type transistor NS6 is lowered to lower the gate voltage of the first current driver transistor PA1. Accordingly, the impedance of the first current driver transistor PA1 is lowered to raise the potential of the output node ND1.

In this way, the result of lowering the potential of the output node ND1 by lowering the impedance of the n-type transistor NT2 is fed back, and the potential of the output node ND1 is raised by lowering the impedance of the first current driver transistor PA1. As a result, an equilibrium state is made, in which the voltage of the input signal Vin and the voltage of the output signal Vout are substantially the same, the gate voltage of the first driver transistor NTO1 is determined to the most appropriate level.

Incidentally, when the following inequality is true, since the p-type differential amplifier circuit 100 and the n-type differential amplifier circuit 110 operate to determine the potentials of the output nodes ND1, ND2, the equilibrium state is made, in which the voltage of the input signal Vin and the voltage of the output signal Vout are substantially the same, without operating the first and the second auxiliary circuits 130, 140.
VDD−|Vthp|≧Vin≧Vthn+VSS

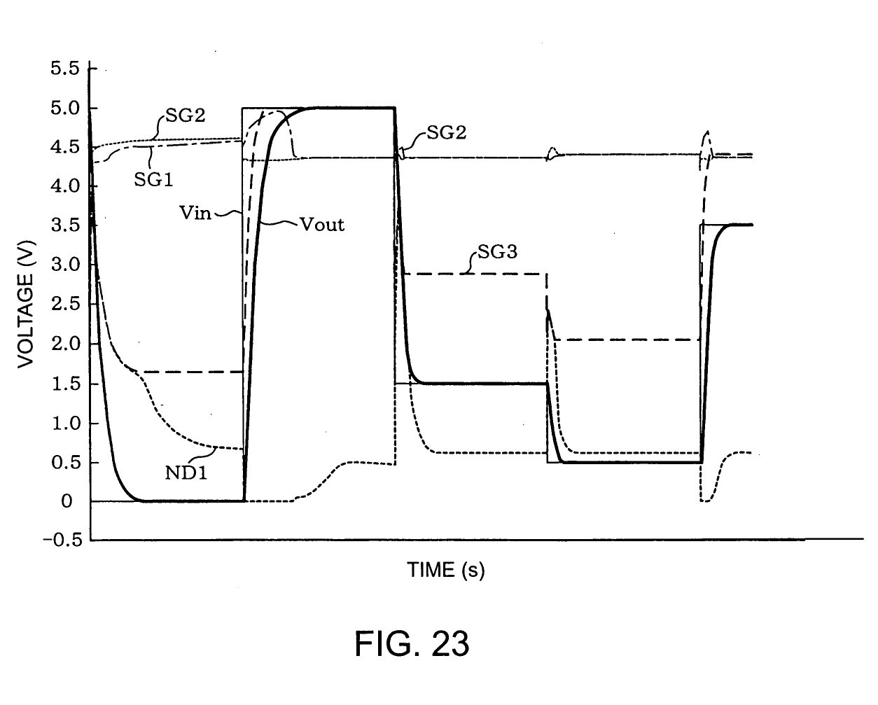

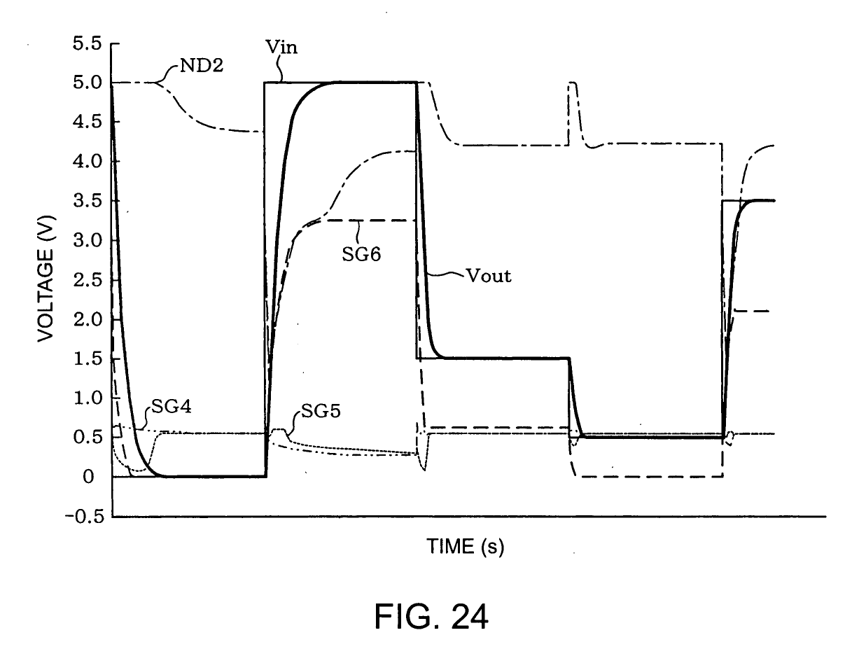

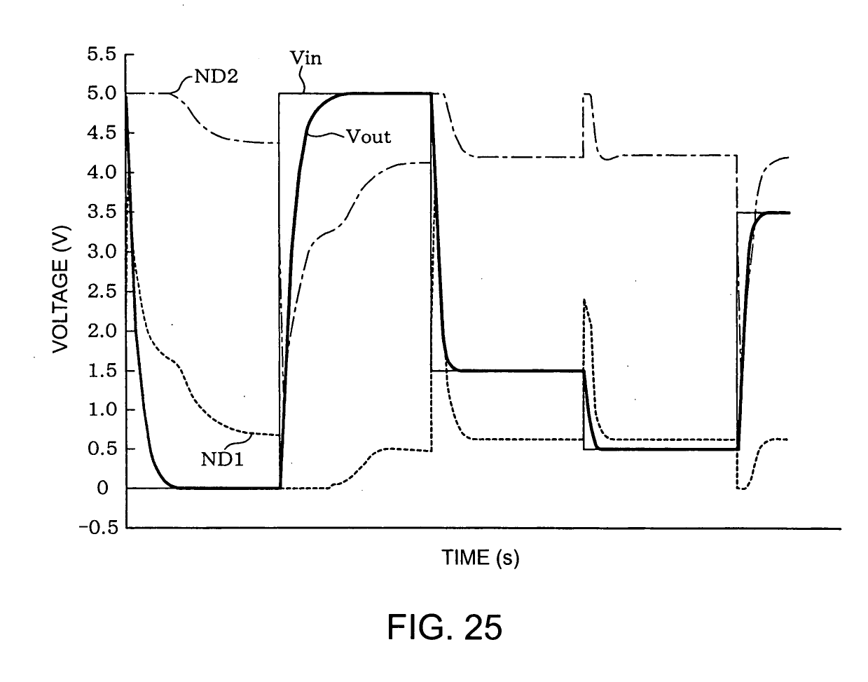

FIG. 23 shows a simulation result of the voltage variations at the nodes of the p-type differential amplifier circuit 100 and the first auxiliary circuit 130. FIG. 24 shows a simulation result of the voltage variations at the nodes of the n-type differential amplifier circuit 110 and the second auxiliary circuit 140. Further, FIG. 25 shows a simulation result of the voltage variations at the output nodes ND1, ND2.

In FIG. 23, a node SG1 represents the gate of the first current driver transistor PA1. A node SG2 represents the gate of the second current driver transistor PA2. A node SG3 represents the sources of the p-type transistors PT1, PT2 forming the first differential pair of transistors.

In FIG. 24, a node SG4 represents the gate of the fourth current driver transistor NA4. A node SG5 represents the gate of the third current driver transistor NA3. A node SG6 represents the sources of the n-type transistors NT3, NT4 forming the second differential pair of transistors.

As also shown in FIGS. 23 through 25, even when the input signal of around 0.5 volt is input, the output node ND1 does not turn into the indefinite state, but controls the gate voltage of the first driver transistor NTO1 composing the output circuit 120.

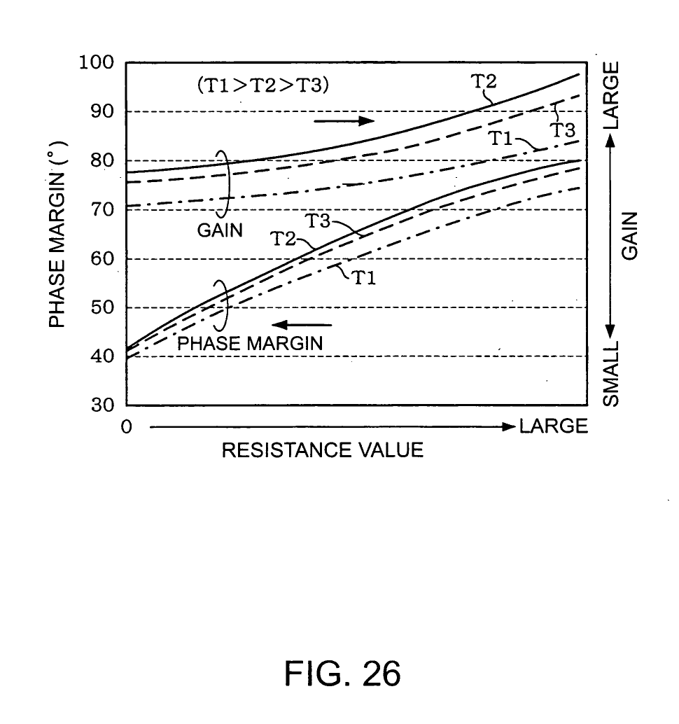

FIG. 26 shows a result of simulation regarding variations of the phase margin and the gain of the impedance conversion circuit IPC in the load-unconnected state including the voltage follower circuit VF having the configuration shown in FIGS. 19 through 21. Here, how the phase margin and the gain vary in accordance with the resistance value of the resistor circuit RC is shown for each of the operational temperatures T1, T2, and T3 (T1>T2>T3). As described above, in the impedance conversion circuit IPC, the phase margin in the load-unconnected state can be specified by changing the resistance value of the resistor circuit RC.

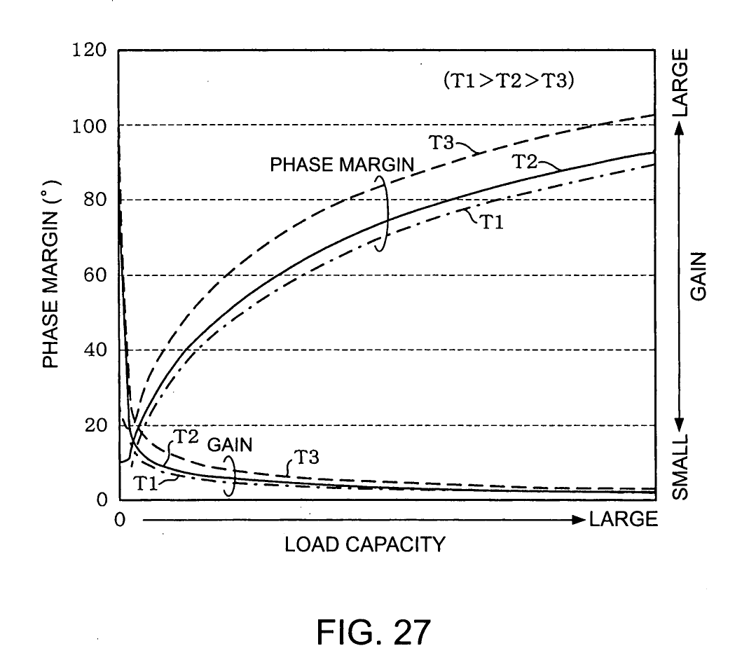

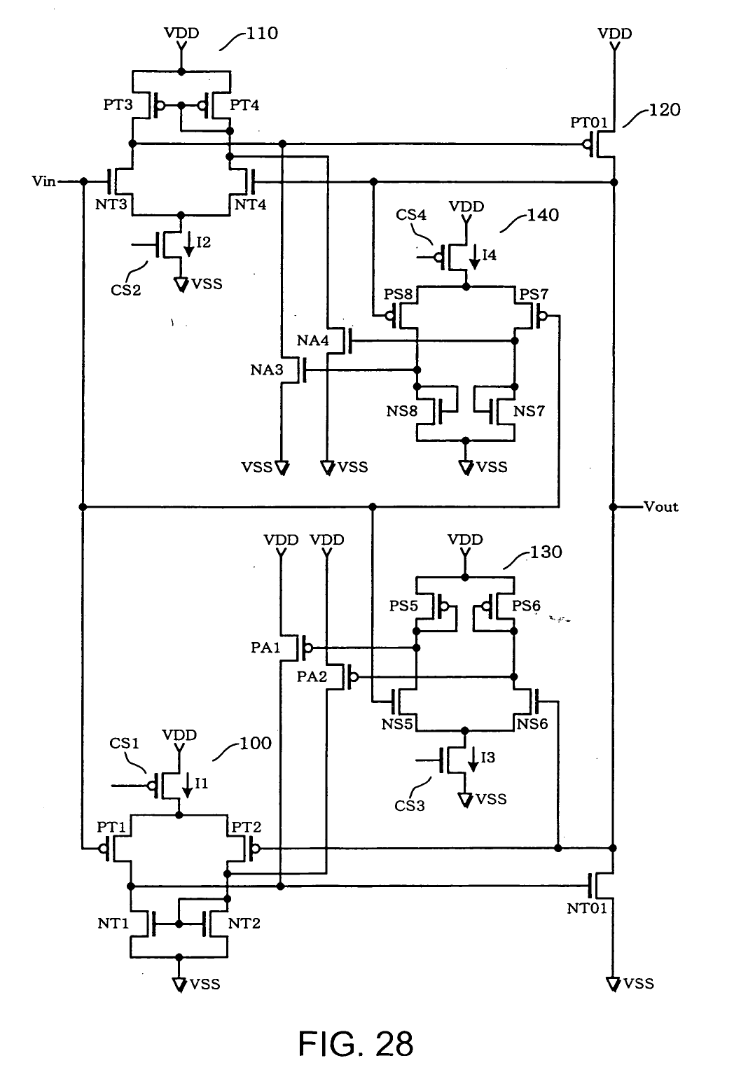

FIG. 27 shows a result of simulation regarding variations of the phase margin and the gain of the impedance conversion circuit IPC in the load-connected state including the voltage follower circuit VF having the configuration shown in FIGS. 19 through 21. Here, how the phase margin and the gain vary in accordance with the load capacitance of the load LD is shown for each of the operational temperatures T1, T2, and T3 (T1>T2>T3) with the resistance value of the resistor circuit RC fixed. As shown in the drawings, in the impedance conversion circuit IPC, the larger the load capacitance of the load LD becomes, the larger the phase margin becomes.

As described above, according to the impedance conversion circuit IPC including the voltage follower circuit VF of the present embodiment, the so called rail-to-rail operation with no input dead zone can be realized, and the control of surely suppressing the through current in the output circuit 120 can also be realized. Thus, the impedance conversion circuit capable of realizing significant low power consumption can be provided. Further, since class AB operation is possible, in polarity reversing driving for reversing voltage applied to liquid crystal, the data lines can stably be driven regardless of the polarity.

And, since the output nodes ND1, ND2 are driven by the first and the second auxiliary circuits 130, 140, speeding up of the reaction speed of the differential section DIF can be realized, and the phase compensation capacitors can also be eliminated. Further, by commonly degrading the current drive capacities of the first and the second driver transistors PTO1, NTO1 of the output section OC, the reaction speed of the output section OC can be slowed. Therefore, various display panels having different load capacitances due to expansion of the panel size can advantageously be driven using the same impedance conversion circuit.

Further, a voltage follower circuit in which the output signal Vout is fed back needs to prevent oscillation in order for stabilizing the output, and accordingly a phase compensation capacitance is generally connected between the differential amplifier circuit and the output circuit to provide the phase margin. In this case, it is known that the slew rate S representing the performance of the voltage follower circuit is proportional to I/C, where I denotes the current consumption and C denotes the capacitance value of the phase compensation capacitor. Therefore, in order for making the slew rate of the voltage follower circuit higher, there is no other way than reducing the capacitance C or increasing the current consumption I.

In contrast, in the present embodiment, since the phase compensation capacitor is eliminated as described above, the slew rate equation described above gives no limitation to the present embodiment. Therefore, the slew rate can be improved without increasing the current consumption I.

3. 3 Adjustment of Current Value

In the voltage follower circuit VF of the present embodiment, the operating current values of the current sources of the p-type differential amplifier circuit 100, the n-type differential amplifier circuit 110, the first auxiliary circuit 130, and the second auxiliary circuit 140 can be arranged to further enhance the stability of the circuits.

FIG. 28 shows a circuit diagram of another configuration example of the voltage follower circuit VF in the present embodiment. In FIG. 28, each of the current sources is composed of a transistor. In this case, wasteful current consumption in the current sources can be reduced by controlling the gate voltage of each of the transistors.

It is effective for enhancing the stability of the voltage follower circuit VF to equalize the drain currents of the first and the second driver transistors NTO1, PTO1 forming the output circuit 120. The drain current of the first driver transistor NTO1 is determined by the operating current value I1 of the first current source CS1 of the p-type differential amplifier circuit 100 and the operating current value I3 of the third current source CS3 of the first auxiliary circuit 130. The drain current of the second driver transistor PTO1 is determined by the operating current value I2 of the second current source CS2 of the n-type differential amplifier circuit 110 and the operating current value I4 of the fourth current source CS4 of the second auxiliary circuit 140.

It is assumed here that the current value I1 is not equal to the current value I3. For example, it is assumed that the current value I1 is 10 while the current value I3 is 5. Similarly, it is assuming that the current value I2 is not equal to the current value I4. For example, it is assumed that the current value I2 is 10 while the current value I4 is 5.

When the input voltage Vin is in the operable range for both the p-type differential amplifier circuit 100 and the first auxiliary circuit 130, the drain current flowing through the first driver transistor NTO1 corresponds to, for example, 15 (=I1+I3=10+5). Similarly, when the input voltage Vin is in the operable range for both the n-type differential amplifier circuit 110 and the second auxiliary circuit 140, the drain current flowing through the second driver transistor PTO1 corresponds to, for example, 15 (=I2+I4=10+5).

On the contrary, when the voltage of the input signal Vin becomes too low for the n-type transistors to operate, the n-type differential amplifier circuit 110 and the first auxiliary circuit 130 no more operate. Therefore, the current stops flowing from the second and the third current sources CS2, CS3 (I2=0, I3=0). Accordingly, the drain current flowing through the first driver transistor NTO1 corresponds to, for example, 10 (=I1), and the drain current flowing through the second driver transistor PTO1 corresponds to, for example, 5 (=I4). For example, the same is applied to the case in which the voltage of the input signal Vin rises too high for the p-type transistors to operate.

As described above, if the drain currents of the first and the second driver transistors composing the output circuit 120 are different, and accordingly, the rising shapes or the falling shapes of the output signal Vout are different from each other, the times necessary for stabilizing the output are different, thus easily causing oscillation.

Therefore, in the voltage follower circuit VF of the present embodiment, the operation current values of the first and the third current sources CS1, CS3 are preferably the same (I1=I3), and the operating current values of the second and the fourth current sources CS2, CS4 are preferably the same (I2=I4). This can be achieved by using the channel length L commonly in the transistors forming the first through the fourth current sources CS1 through CS4, making the channel widths of the transistors forming the first and the third current sources CS1, CS3 the same, and making the channel widths of the transistors forming the second and the fourth current sources CS2, CS4 the same.

Further, the operating current values of the first through fourth current sources CS1 through CS4 are preferably the same (I1=I2=I3=I4). Because the design can be easier in this case.

Further, by reducing at least one of the operating current values of the third and the fourth current sources CS3, CS4, further low power consumption can be achieved. In this case, the at least one of the operating current values of the third and the fourth current sources CS3, CS4 needs to be reduced without degrading the current drive capacity of each of the first through the fourth current driver transistors PA1, PA2, NA3, NA4.

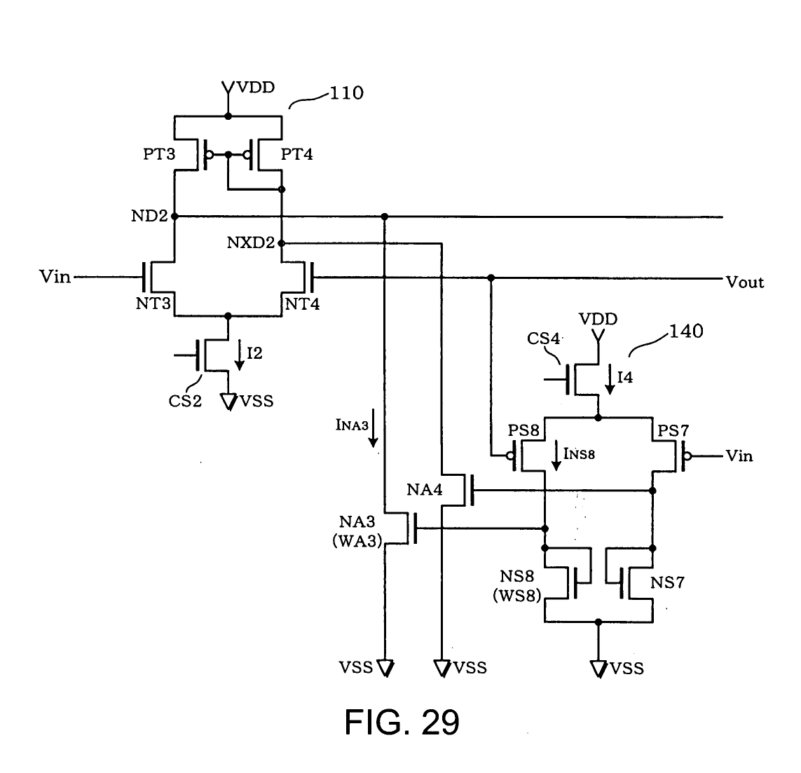

FIG. 29 shows a diagram for explaining an example of a configuration capable of reducing the operating current value of the fourth current source CS4. Note that the same parts as those of the operational amplifier shown in FIGS. 19, 22, or 28 are denoted with the same reference numerals and explanations therefor are omitted if appropriate.

In FIG. 29, it is utilized for reducing the operating current value of the fourth current source CS4 that the third and the eighth current driver transistors NA3, NS8 composes a current mirror circuit. The channel length of the third current driver transistor NA3 is denoted with L, the channel width thereof is denoted with WA3, the drain current of the third current driver transistor NA3 is denoted with I_{NA3}, the channel length of the eighth current driver transistor NS8 is denoted with L, the channel width thereof is denoted with WS8, and the drain current of the third current driver transistor NS8 is denoted with I_{NS8}. In this case, the relationship can be expressed as the following. I_{NA3}=(WA3/WS8)×I_{NS8} Here, (WA3/WS8) expresses the ratio of the current drive capacity of the third current driver transistor NA3 to the current drive capacity of the eighth current driver transistor NS8. Accordingly, by arranging (WA3/WS8) greater than 1, the drain current INS8 can be reduced without degrading the current drive capacity of the third current driver transistor NA3, and the operating current of the fourth current source CS4 can also be reduced.

Note that, in FIG. 29, it can also be utilized that the fourth and the seventh current driver transistors NA4, NS7 compose a current mirror circuit.

Further, it is also preferable to reduce the operating current value of the third current source CS3. In this case, it can be utilized that the first and the sixth current driver transistors PA1, PS6 compose a current mirror circuit, or that the second and the fifth current driver transistors PA2, PS5 compose a current mirror circuit.

As described above, at least one of the ratio of the current drive capacity of the first current driver transistor PA1 to the current drive capacity of the sixth current driver transistor PS6, the ratio of the current drive capacity of the second current driver transistor PA2 to the current drive capacity of the fifth current driver transistor PS5, the ratio of the current drive capacity of the third current driver transistor NA3 to the current drive capacity of the eighth current driver transistor NS8, and the ratio of the current drive capacity of the fourth current driver transistor NA4 to the current drive capacity of the seventh current driver transistor NS7 is arranged to be greater than 1. By thus arranging, at least one of the operating current values of the third and the fourth current sources CS3, CS4 can be reduced.

Note that the present invention is not limited to the embodiment described above, but can be put into practice with various modification within the scope or the spirit of the present invention. For example, although the application to a liquid crystal display panel as a display panel is described, there is no limitation thereto. Further, although the transistors are described as MOS transistors, they are not limited thereto.

Further, the configuration of the voltage follower circuit, the configurations of the p-type differential amplifier circuit, the n-type differential amplifier circuit, the output circuit, the first auxiliary circuit, and the second auxiliary circuit all composing the voltage follower circuit are not limited to those described in the above embodiment, but various equivalent configurations thereto can also be adopted.

Further, in the aspects of the present invention corresponding to the dependent claims, configurations lacking a part of elements of the independent claim thereof can also be adopted. Further, a substantial part of one independent claim can be dependent from another independent claim.

What is claimed is:

1. A source driver for driving a plurality of source lines of an electro-optic device, comprising:
a plurality of impedance conversion circuits each driving a respective one of the plurality of source lines in accordance with a grayscale voltage corresponding to display data; and
a plurality of power save data storing circuits each storing power save data, wherein
each of the plurality of power save data storing circuits is provided for one of each of the plurality of impedance conversion circuits and a number of impedance conversion circuits, the number corresponding to the number of dots forming a pixel,
each of the plurality of impedance conversion circuits includes a voltage follower circuit for driving one of the plurality of source lines and having a smaller phase margin without a load connected to an output thereof than with a load connected to the output thereof,
and, an operating current of the voltage follower circuit included in the impedance conversion circuit is one of stopped and limited in accordance with the power save data stored in the power save data storing circuit corresponding to the impedance conversion circuit.

2. The source driver according to claim 1, wherein
the plurality of power save data storing circuits is configured as a shift register in which each of the plurality of power save data storing circuits is connected in series with each other,
the power save data is sequentially set to each of the plurality of power save data storing circuits with a shift operation.

3. The source driver according to claim 1, further comprising:
a display data memory for storing the display data corresponding to each of the plurality of impedance conversion circuit and the power save data corresponding to each of the plurality of power save data storing circuits, wherein
the power save data is read out from the display data memory, and then set to each of the plurality of power save data storing circuits.

4. The source driver according to claim 2, wherein
a first power save data for setting the impedance conversion operation of an impedance conversion circuit group specified by designated two of the plurality of impedance conversion circuits to an enabled state is generated, and the first power save data is set to one of at least one of the plurality of power save data storing circuits and the display data memory.

5. The source driver according to claim 4, wherein
a second power save data for setting the plurality of impedance conversion circuits other than the impedance conversion circuit group to a disabled state, in which an operating current of the voltage follower circuit is one of inhibited and limited, is generated, and the second power save data is set to one of at least one of the plurality of power save data storing circuits and the display data memory.

6. The source driver according to claim 1, wherein
each of the plurality of impedance conversion circuits further includes a resistor circuit connected in series between the voltage follower circuit and the output of the impedance conversion circuit,
the voltage follower circuit includes a differential section for amplifying difference between the input signal and the output signal of the voltage follower circuit, and an output section for outputting the output signal of the voltage follower circuit based on the output of the differential section,
the plurality of source lines is driven via the resistor circuit.

7. The source driver according to claim 6, wherein
a slew rate of the output of the differential section is one of equal to and higher than a slew rate of the output of the output section.

8. An electro-optic device, comprising:
a plurality of source lines;
a plurality of gate lines;
a plurality of switching elements each connected to one of the plurality of gate lines and one of the plurality of source lines;
a gate driver for scanning the plurality of gate lines; and
the source driver according to claim 1 for driving the plurality of source lines.

9. A method for driving a plurality of source lines of an electro-optic device, comprising:
storing power save data to a power save data storing circuit provided for one of a voltage follower circuit for driving one of the plurality of source lines in accordance with a grayscale voltage corresponding to a display data, and a number of voltage follower, the number corresponding to the number of dots forming a pixel; and
one of inhibiting and limiting an operating current of the voltage follower circuit in accordance with the power save data stored in the power save data storing circuit provided for the voltage follower circuit, wherein
the voltage follower circuit has a smaller phase margin without a load connected to the output thereof than with a load connected to the output thereof.

10. The method according to claim 9, comprising:
generating a first power save data for setting the operation of a voltage follower circuit group to an enabled state, the voltage follower circuit group being specified by two of the plurality of voltage follower circuits each driving a source line; and
setting the first power save data to at least one of the plurality of power save data storing circuits.

11. The method according to claim 10, comprising:
generating a second power save data for setting the voltage follower circuit group to a disabled state in which an operating current thereof is one of inhibited and limited, the voltage follower circuit group being specified by two of the plurality of voltage follower circuits each driving a source line; and
setting the second power save data to at least one of the plurality of power save data storing circuits.
